(19) United States
(12) Patent Application Publication
(10) Pub. No.: US 2025/0057307 A1
(43) Pub. Date: Feb. 20, 2025

(54) ORAL CARE IMPLEMENT

(71) Applicant: Colgate-Palmolive Company, New York, NY (US)

(72) Inventors: Joppe Gideon VAN DIJK, Rotterdam (NL); Tim Anton Snijder, Rotterdam (NL); Thomas Van De Water, Den Haag (NL); Salvador Lluch Sicard, Den Haag (NL)

(73) Assignee: Colgate-Palmolive Company, New York, NY (US)

(21) Appl. No.: 18/794,334

(22) Filed: Aug. 5, 2024

Related U.S. Application Data
(60) Provisional application No. 63/532,466, filed on Aug. 14, 2023.

(51) Int. Cl. A46B 9/04; A46B 13/02; A46D 1/08; A46D 3/00; A61C 17/22; A61C 17/34

(52) U.S. Cl. CPC A46B 9/045; A46B 13/023; A46D 1/08; A46D 3/00; A61C 17/222; A61C 17/3481

(57) ABSTRACT

An oral care implement which incorporates a head coupled to a handle. The head has a neck portion and a head portion. The head portion is formed of a base structure, a plurality of tuft blocks mounted on the base structure, and a guard structure covering the base structure. The plurality of tuft blocks each have a plurality of bristle tufts. In some configurations, the head portion may have a wall and a plurality of fingers. The wall may extend in a concave shape which is formed by a plurality of bends located between adjacent tuft blocks.

### CROSS-REFERENCE TO RELATED APPLICATIONS

The present application claims priority to U.S. Provisional Patent Application Ser. No. 63/532,466, filed Aug. 14, 2023, the entirety of which is incorporated herein by reference.

### BACKGROUND

Oral care, particularly care of an individual's teeth and gums, are of utmost importance to ensure overall health. However, typical oral care routines are time consuming. For instance, most dentists recommend brushing teeth for a minimum of two minutes. Those individuals who may have dexterity problems or may not wish to spend the required time brushing may suffer from poor oral health. Thus, a need exists for oral care implements which remedy the deficiencies in existing products.

### BRIEF SUMMARY

The present invention is directed to an oral care implement having a handle and a head coupled to the handle. The head has a neck portion and a head portion coupled to the neck portion. The head portion has a base structure, a plurality of tuft blocks in contact with the base structure, and a guard structure. Each of the plurality of tuft blocks has a front surface, a rear surface, a perimeter extending from the front surface to the rear surface, and a plurality of bristle tufts extending from the front surface of each of the plurality of tuft blocks. The guard structure encapsulates the base structure and surrounds the perimeter of a first one of the plurality of tuft blocks.

In one aspect, the invention may be a head of an oral care implement having a neck portion and a head portion coupled to the neck portion. The head portion has a base structure, a plurality of tuft blocks, and a guard structure. The base structure has a front surface and an opposite rear surface. Each of the plurality of tuft blocks have a front surface, a rear surface, and a plurality of bristle tufts extending from the front surface of each of the tuft blocks. The guard structure encapsulates the base structure. A first portion of the front surface of the base structure is in direct surface contact with a first one of the plurality of tuft blocks.

In another aspect, the invention may be a method of manufacturing a head of an oral care implement. The method has a first step of providing a base structure, the base structure having a front surface and an opposite rear surface. The method has a second step of forming a first tuft block having a plurality of tuft holes extending from a front surface, the first tuft block in contact with a portion of the front surface of the base structure or a first portion of the rear surface of the base structure. In a third step, the front and rear surfaces of the base structure are encapsulated while leaving the front surface of the first tuft block exposed to form a head assembly.

In a further aspect, the invention may be an oral care implement having a handle and a head coupled to the handle. The head has a neck portion and a head portion coupled to the neck portion. The head portion has a base structure, a plurality of tuft blocks in contact with the base structure, and a guard structure. The base structure has a front surface, a rear surface, and an aperture. Each of the plurality of tuft blocks has a front surface, a rear surface, a perimeter extending from the front surface to the rear surface, and a plurality of tuft holes formed in the front surface of each of the plurality of tuft blocks, a plurality of bristle tufts extending from the plurality of tuft holes. The guard structure is in direct surface contact with the front or rear surface of the base structure. A first one of the plurality of tuft holes of a first one of the plurality of tuft blocks extends through the aperture of the base structure.

In one aspect, the invention may be a head of an oral care implement having a neck portion and a head portion coupled to the neck portion. The head portion has a base structure, a plurality of tuft blocks, and a guard structure. The base structure has a front surface, a rear surface, and an aperture. The plurality of tuft blocks are in contact with the base structure, each of the plurality of tuft blocks having a front surface, a rear surface, a perimeter extending from the front surface to the rear surface, and a plurality of tuft holes formed in the front surface of each of the plurality of tuft blocks. A plurality of bristle tufts extend from the plurality of tuft holes. The guard structure is in direct surface contact with the front or rear surface of the base structure. A first one of the plurality of tuft holes of a first one of the plurality of tuft blocks has a depth which is equal to a height of the first one of the plurality of tuft blocks.

In another aspect, the invention may be a method of manufacturing a head of an oral care implement. The method has a first step of providing a base structure, the base structure having a front surface and an opposite rear surface. The method has a second step of forming a first tuft block having a plurality of tuft holes, the first tuft block in contact with the base structure. Finally, the method has a third step of covering the base structure while leaving the plurality of tuft holes of the first tuft block exposed to form a head subassembly.

In a further aspect, the invention may be an oral care implement having a handle and a head coupled to the handle. The head has a neck portion and a head portion coupled to the neck portion. The head portion has a base structure, a plurality of tuft blocks, and a guard structure. The base structure has a plurality of pre-weakened areas. The plurality of tuft blocks are in contact with the base structure, each of the plurality of tuft blocks having a plurality of bristle tufts. The guard structure encapsulates the base structure and covers the plurality of pre-weakened areas.

In one aspect, the invention may be a head of an oral care implement having a neck portion and a head portion coupled to the neck portion. The head portion has a base structure, a plurality of tuft blocks, and a guard structure. The base structure has a plurality of pre-weakened areas. The plurality of tuft blocks are in contact with the base structure, each of the plurality of tuft blocks comprising a plurality of bristle tufts. A first one of the plurality of tuft blocks is located between a first one of the plurality of pre-weakened areas and a second one of the plurality of pre-weakened areas. The guard structure encapsulates the base structure and covers the plurality of pre-weakened areas.

In another aspect, the invention may be a method of manufacturing a head of an oral care implement. The method has a first step of providing a base structure. The method has a second step of forming first and second tuft blocks each having a plurality of tuft holes. The first and second tuft blocks are in contact with the base structure, the first tuft block spaced and isolated from the second tuft block. In a third step, the method requires covering at least a portion of the base structure with a guard structure. In a fourth step, the base structure is bent to form a first bend between the first and second tuft blocks.

In a further aspect, the invention may be an oral care implement having a handle and a head coupled to the handle. The head has a neck portion having a connector and a head portion coupled to the neck portion. The head portion has a wall, a plurality of fingers extending from the wall, a connector coupled to the wall and the connector of the neck portion, and first and second bends located along the wall. The connector of the neck portion covers at least a portion of the first and second bends.

In one aspect, the invention may be a head of an oral care implement having a neck portion having a connector and a head portion coupled to the neck portion. The head portion has a wall, a plurality of fingers extending from the wall, a connector coupled to the wall and the connector of the neck portion, and first and second bends located along the wall. Each of the first and second bends has a spring rate, the connector of the neck portion increasing the spring rate of the first and second bends.

In another aspect, the invention may be a method of assembling a head of an oral care implement. The method has a first step of providing a head portion of a head, the head portion having a wall, a plurality of fingers extending from the wall, a connector coupled to the wall, and first and second bends located along the wall. The method has a second step of coupling a connector of a neck portion to the connector of the head portion such that the connector of the neck portion is in contact with the first and second bends of the head portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an oral care implement in accordance with an embodiment of the present invention;

FIG. 2 is a perspective view of a head of the oral care implement of FIG. 1;

FIG. 3 is a front view of the head of FIG. 2;

FIG. 4 is a rear view of the head of FIG. 2;

FIG. 5 is a right side view of the head of FIG. 2;

FIG. 6 is a left side view of the head of FIG. 2;

FIG. 7 is a top view of the head of FIG. 2;

FIG. 8 is a bottom view of the head of FIG. 2;

FIG. 9 is a perspective view of the head of FIG. 2 illustrated in a flat state;

FIG. 10 is a front view of the head of FIG. 9;

FIG. 11 is a rear bottom view of the head of FIG. 9;

FIG. 12 is a right side view of the head of FIG. 9;

FIG. 13 is a left side view of the head of FIG. 9;

FIG. 14 is a top view of the head of FIG. 9;

FIG. 15 is a bottom view of the head of FIG. 9;

FIG. 16 is a cross-section view of the head, taken along line 16-16 of FIG. 9;

FIG. 17 is a cross-section view of the head, taken along line 17-17 of FIG. 9;

FIG. 18 is a perspective view of a base structure used to form a head portion of the head of FIG. 2;

FIG. 19 is a perspective view of the base structure and a plurality of tuft blocks used to form the head portion;

FIG. 19A is a detail cross-section view of a portion of the base structure and one of the plurality of tuft blocks of FIG. 19;

FIG. 20 is a lower rear perspective view of the base structure and the plurality of tuft blocks;

FIG. 21 is a perspective view of a head subassembly used to form the head portion of the head of FIG. 2;

FIG. 22 is a perspective view of the head portion after assembling a plurality of tooth cleaning elements to the head subassembly, the head portion in the flat state;

FIG. 22A is a detail cross-section view of a portion of the head portion of FIG. 22;

FIG. 23 is a perspective view of the head portion, the head portion in a first partially bent state;

FIG. 24 is a lower rear perspective view of the head portion, the head portion in the first partially bent state;

FIG. 25 is a perspective view of the head portion, the head portion in a second partially bent state;

FIG. 26 is a lower rear perspective view of the head portion, the head portion in the second partially bent state;

FIG. 27 is a perspective view of the head portion, the head portion in a fully bent state;

FIG. 28 is a lower rear perspective view of the head portion, the head portion in the fully bent state;

FIG. 29A is a schematic cross-section view illustrating a first alternate construction of the head portion;

FIG. 29B is a schematic cross-section view illustrating a second alternate construction of the head portion;

FIG. 29C is a schematic cross-section view illustrating a third alternate construction of the head portion;

FIG. 30A is a partial schematic cross-section view illustrating a fourth alternate construction of the head portion;

FIG. 30B is a partial schematic cross-section view illustrating a fifth alternate construction of the head portion;

FIG. 30C is a partial schematic cross-section view illustrating a sixth alternate construction of the head portion;

FIG. 31A is a partial schematic cross-section view illustrating a seventh alternate construction of the head portion;

FIG. 31B is a partial schematic cross-section view illustrating an eighth alternate construction of the head portion;

FIG. 32A is a schematic top view of a ninth alternate construction of the head portion with the bristles and guard structure omitted;

FIG. 32B is a detail view of a finger of the head portion of FIG. 32A;

FIG. 33 is a top view of an alternate construction of the base structure as may be used in the head of FIG. 2;

FIG. 34A is a schematic top view of a tenth alternate construction of the head portion with the bristles and guard structure omitted;

FIG. 34B is a detail view of a finger of the head portion of FIG. 34A;

FIG. 35 is a schematic top view of an eleventh alternate construction of the head portion with the bristles and guard structure omitted;

FIG. 36 is a top view of another alternate construction of the base structure as may be used in the head of FIG. 2;

FIG. 37 is a partial perspective view of another alternate construction of the base structure as may be used in the head of FIG. 2;

FIG. 38 is a partial perspective view of another alternate construction of the base structure as may be used in the head of FIG. 2;

FIG. 39 is a partial perspective view of another alternate construction of the base structure as may be used in the head of FIG. 2;

FIG. 40 is a perspective view of an alternate construction of the head;

FIG. 41 is a perspective view of an alternate embodiment of an oral care implement;

FIG. 42 is a perspective view of a head of the oral care implement of FIG. 41;

FIG. 43 is a cross-section view of the head taken along line 43-43 of FIG. 42;

FIG. 44 is a perspective view of a base structure as may be used in the head of FIG. 42;

FIG. 45 is a perspective view of the base structure and a pair of tuft blocks as may be used in the head of FIG. 42;

FIG. 46 is a lower rear perspective view of the base structure and the pair of tuft blocks of FIG. 45; and

FIG. 47 is a perspective view of a head subassembly used to form the head of FIG. 42.

### DETAILED DESCRIPTION

The following description of the preferred embodiment(s) is merely exemplary in nature and is in no way intended to limit the invention, its application, or uses.

The description of illustrative embodiments of principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

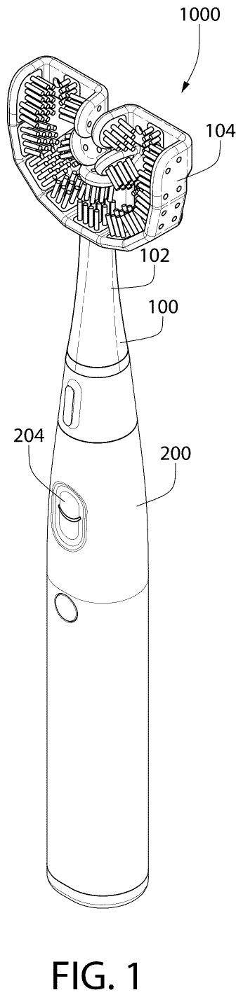

Referring to FIG. 1, an oral care implement 1000 is illustrated in accordance with an embodiment of the present invention. The oral care implement 1000 is a powered device for cleaning a user's teeth and other oral tissues. The oral care implement 1000 has a head 100 and a handle 200, the head 100 having a neck portion 102 and a head portion 104. The handle 200 has a vibration generating device and a user interface 204 configured to control operation of the vibration generating device. The vibration generating device is preferably a motor, but may be any known type of vibration generating device suitable for transmitting vibrations from the handle 200 to the head 100 to excite cleaning elements on the head 100. Optionally, the head 100 may be detachably coupled to the handle 200 or it may be permanently coupled.

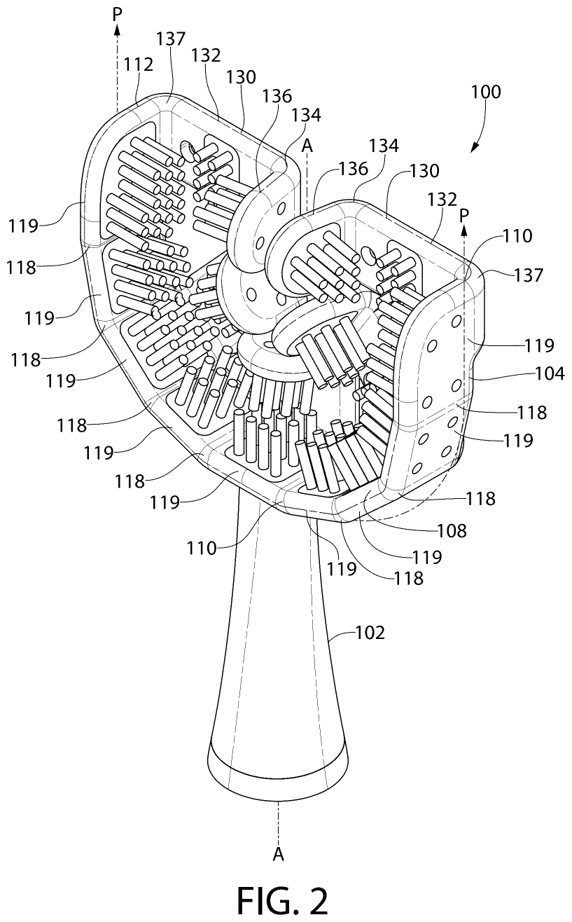

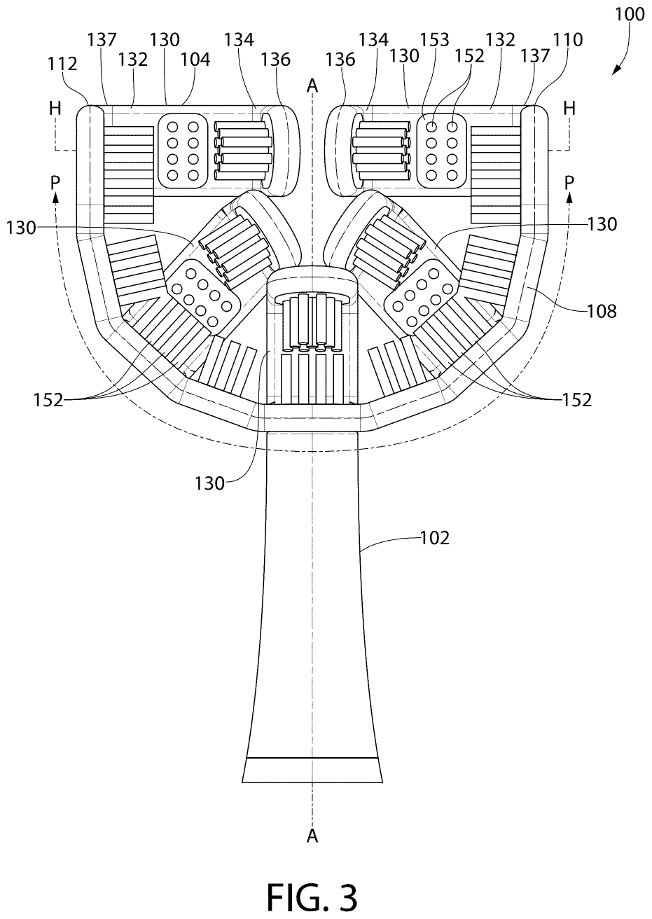

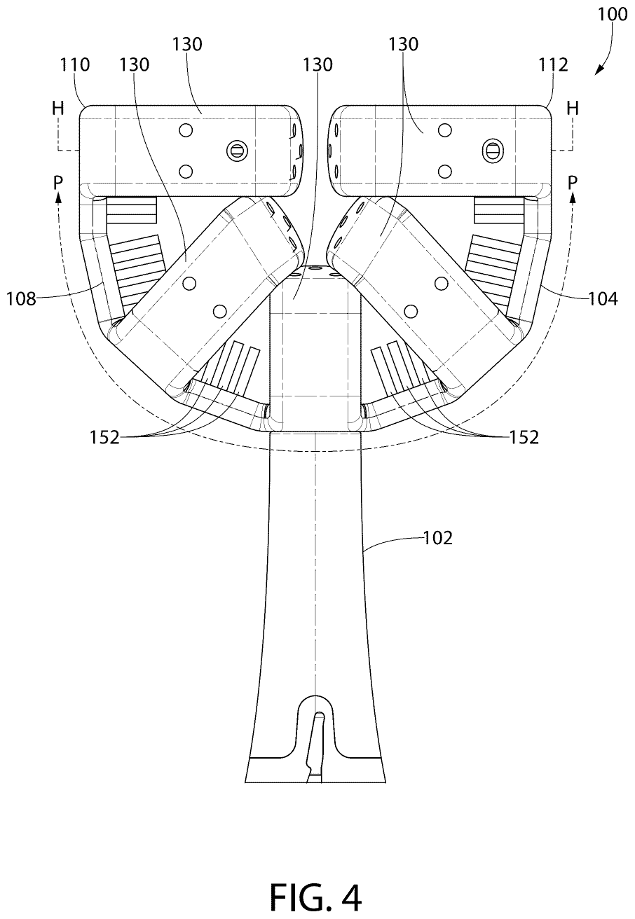

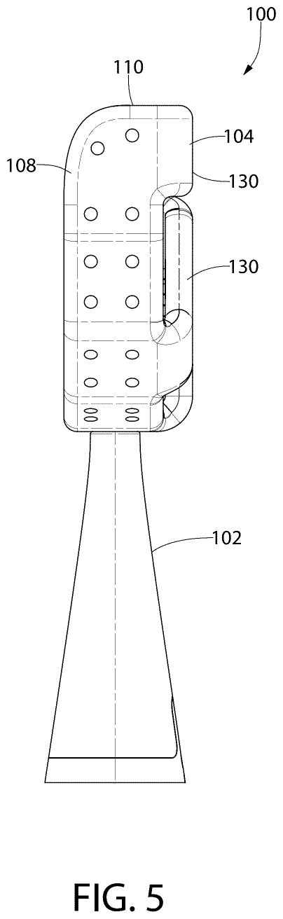

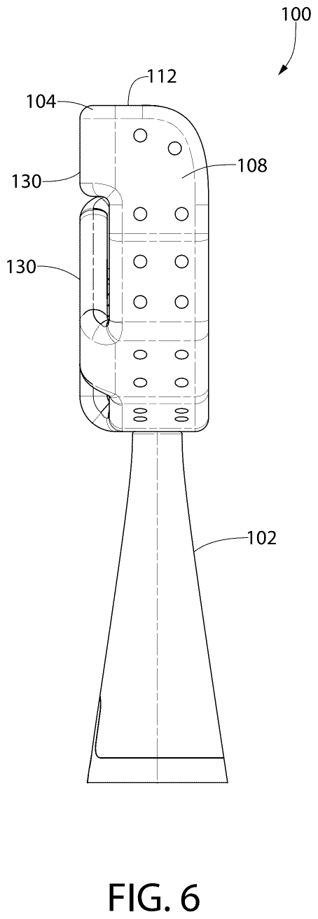

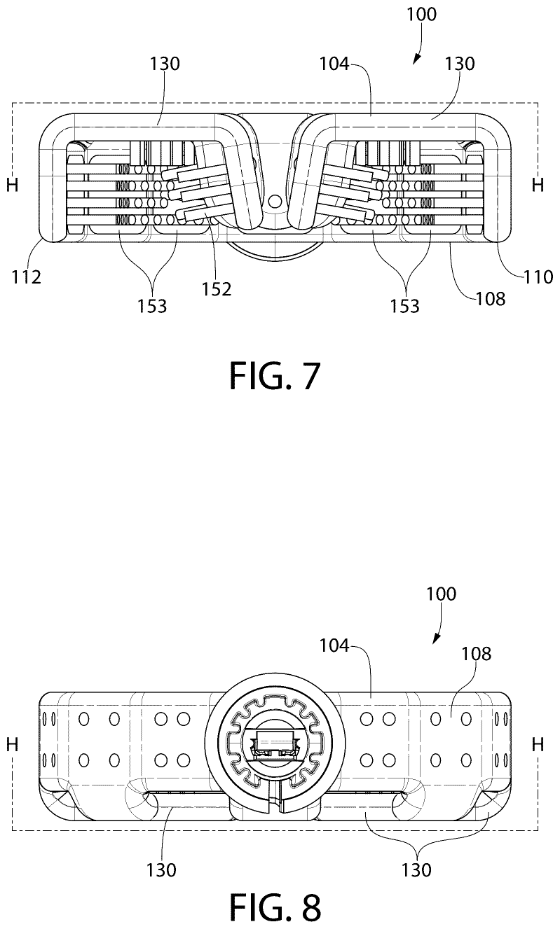

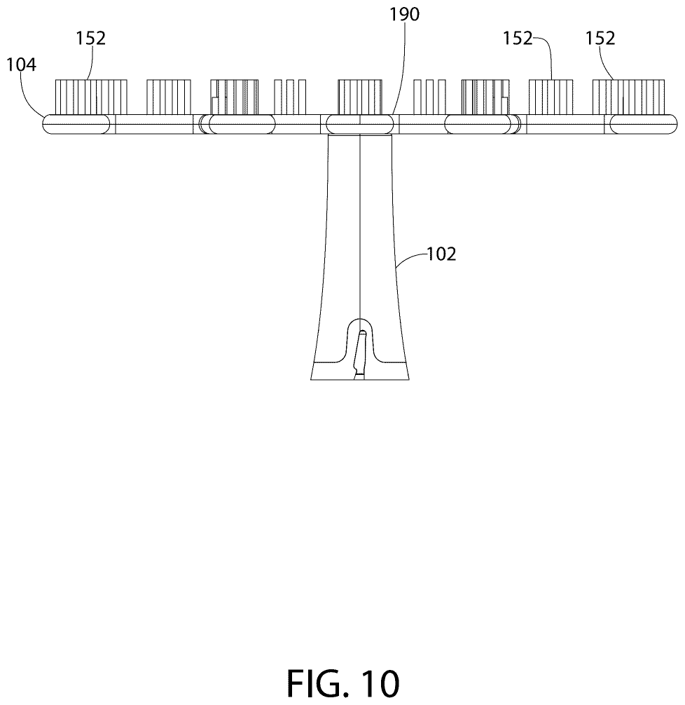

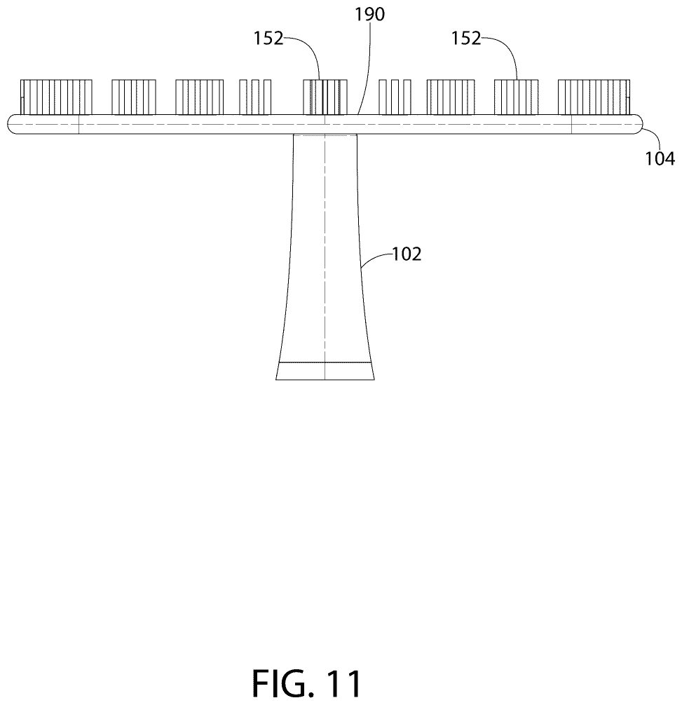

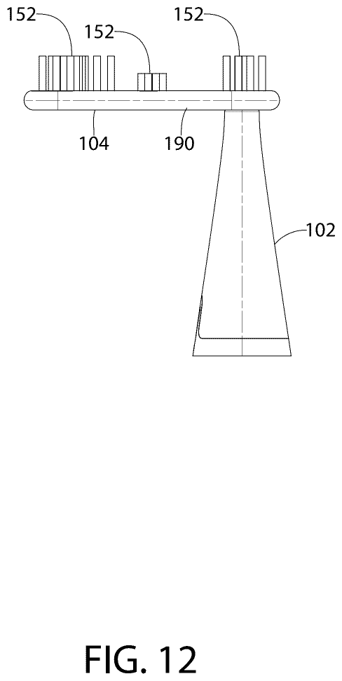

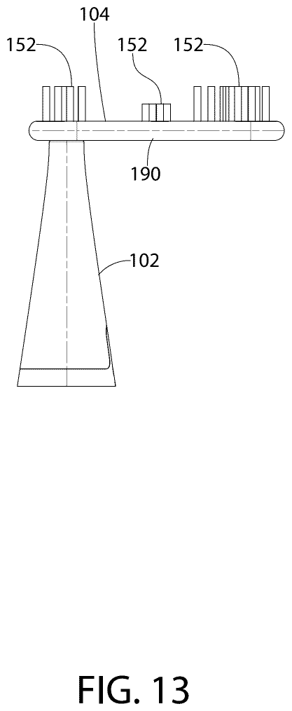

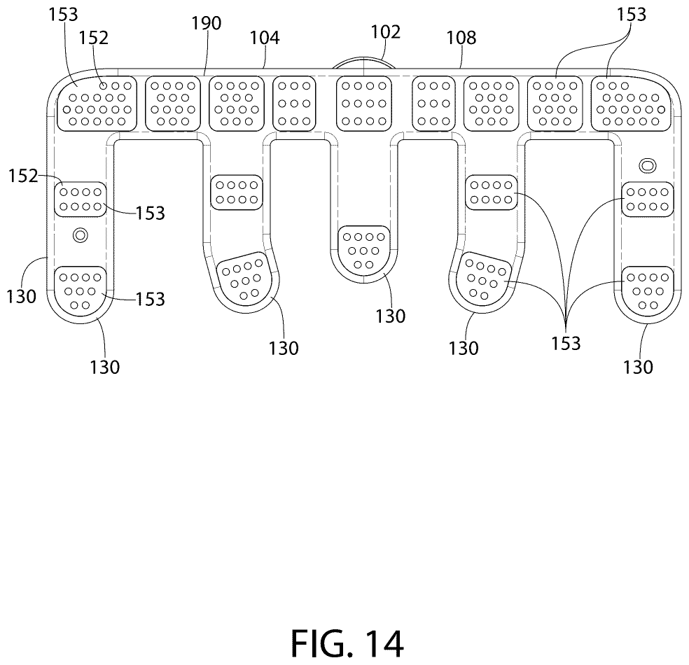

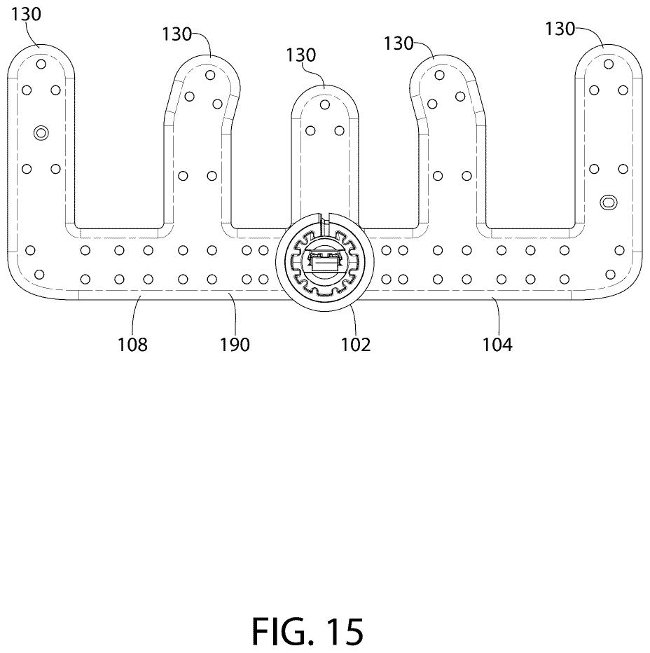

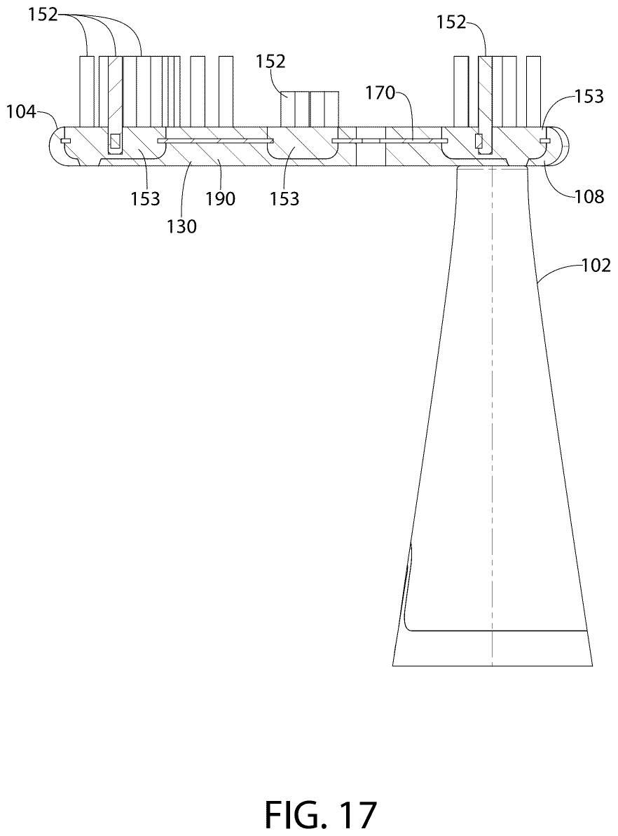

FIGS. 2-17 illustrate the head 100 in greater detail. As discussed above, the head 100 has a head portion 104 coupled to a neck portion 102. The neck portion 102 may engage a stem of the handle 200 or other engagement feature. The head portion 104 is coupled to the neck portion 102 and has a generally arcuate shape suitable for insertion into a user's oral cavity. The head portion 104 is configured to engage a plurality of the user's teeth simultaneously. The head 100 extends along a longitudinal axis A-A.

The head portion 104 extends along a path P-P. The path P-P is generally arcuate, but comprises a plurality of substantially linear segments defined by the shape of a wall of the head portion 104 as will be described in greater detail below. Thus, the path P-P forms a concave shape formed of a plurality of segments separated by bends. In other configurations, the path P-P may be a continuous arc or arcs having smooth transitions. The path P-P may be selected to correspond to a user's dental arch. Optionally, the path P-P may be formed of a combination of arcs and linear segments. In the present embodiment, the path P-P may be any shape forming a generally concave path. The path P-P extends parallel to a horizontal plane H-H, the horizontal plane H-H extending along a bottom surface 106 of the head portion 104.

The head portion 104 further has a wall 108, the wall 108 extending along the path P-P from a first distal end 110 to a second distal end 112. The wall 108 has a generally concave shape but need not take the form of a single arc of constant radius. The wall 108 may instead be a composite concave shape comprising a plurality of bends 118 and substantially linear segments 119, or other geometry that collectively forms a curved shape. A plurality of fingers 130 extend from the wall 108. Optionally, the head portion 104 may be symmetric about the neck portion 102 as illustrated, or the head portion 104 may be asymmetric about the neck portion 102. It is conceived that the head portion 104 may correspond to a user's full dental arch or only a portion of the user's dental arch.

In yet other implementations, the plurality of fingers 130 may not extend from a single wall 108. Instead, the fingers 130 may be arranged into a series of segments such that a plurality of distinct walls 108 are formed about the user's dental arch. When in a flat configuration, the head portion 104 may appear to have a zig-zag shape to form the desired shape for the head portion 104 when in the folded state.

In some implementations, the head portion 104 may be symmetrical and extend along a majority of the user's dental arch. In yet other implementations, the head portion 104 may be asymmetrical such that it extends along less than half of the user's dental arch. In other implementations, the head portion 104 may be configured to cover approximately one half of the user's dental arch. In these implementations, the head portion 104 may engage one side of the user's mouth at a time. The head portion 104 may be moved along the dental arch to brush all teeth of the dental arch. It is further contemplated that the head portion 104 may engage only a single jaw or may engage both upper and lower jaws simultaneously. Where the head portion 104 engages both upper and lower jaws, the fingers 130 may extend in opposite directions to engage different jaws or components of the head portion 104 may be duplicated to allow simultaneous brushing of both top and bottom jaws.

Each of the plurality of fingers 130 each has a horizontal portion 132 extending from the wall 108 along the horizontal plane H-H. The plurality of fingers 130 also has a first bend 134, a tip portion 136, and a second bend 137. The tip portion 136 extends from the horizontal plane H-H at the first bend 134. The tip portions 136 of the fingers 130 diverge from the horizontal plane H-H at the first bend 134. The second bend 137 is located at the transition between the horizontal portion 132 and the wall 108. In the present embodiment there are five fingers 130, but in other embodiments there may be greater or fewer than five fingers 130. As can be seen, the fingers 130 are bent to form an L shape with respect to the horizontal plane H-H. The fingers 130 and the wall 108 generally form a U shape in cross-section. In other implementations, the tip portions 136 of the fingers 130 may extend from both sides of the horizontal plane H-H to enable simultaneous brushing of both top and bottom jaws. In yet other embodiments, the fingers 130 need not all have their horizontal portions 132 lying along the horizontal plane H-H. In these embodiments, the horizontal portions 132 may be angled with respect to one another, parallel but non-planar with respect to one another, or even have a radius of curvature which is greater than a radius of curvature of either of the first and second bends 134, 137.

Each of the fingers 130 is spaced and isolated from the other fingers 130, although in some embodiments the fingers 130 may be in surface contact. Preferably, the fingers 130 are not coupled to one another, but are exclusively coupled to the wall 108. An arcuate channel is formed between the fingers 130 and the wall 108. This arcuate channel effectively surrounds the user's teeth, ensuring brushing on three sides of each tooth simultaneously. Combined with movement along the user's dental arch, all surfaces of all teeth can be reached. The arcuate channel may have a U shape in cross-section but need not be symmetrical.

As can be seen, the head portion 104 has a plurality of bristle tufts 152, the plurality of bristle tufts 152 extending from the wall 108 and the plurality of fingers 130. The fingers 130 may have bristle tufts 152 on both the horizontal portion 132 and the tip portion 136. The bristle tufts 152 are formed of filament bristles, and may be formed of any known bristle filament material. Such materials may include Polybutylene Terephthalate (“PBT”), nylon, polypropylene, or other natural or synthetic materials. In other configurations, the bristle tufts 152 may be formed as a plurality of injection molded bristles, or any other type of molded or filament teeth cleaning elements. In other words, some bristle tufts 152 may be substituted for elastomeric or other molded teeth cleaning elements or for one or more molded bristles.

The plurality of bristle tufts 152 extend from a plurality of tuft blocks 153. The tuft blocks 153 are located on the wall 108 as well as the horizontal portion 132 and tip portion 136 of the fingers 130. Optionally, some of the plurality of fingers 130 may have a tuft block 153 on only one of the horizontal portion 132 or the tip portion 136. By way of example, the central finger 130 has only a single tuft block 153 on the tip portion 136 and no tuft block 153 on the horizontal portion 132. In other implementations, more than one tuft block 153 may be located on the tip portion 136, horizontal portion 132, or the wall 108. Any number of tuft blocks 153 may be utilized at any location on the fingers 130 or wall 108. In other implementations there may be a plurality of separate walls 108 having one or more fingers 130 extending therefrom. In yet other implementations, two separate walls 108 may be formed with fingers connecting the walls 108. These separate walls 108 may be substantially parallel 108 or may be arranged with any other spacing to facilitate cleaning of a user's dental arch.

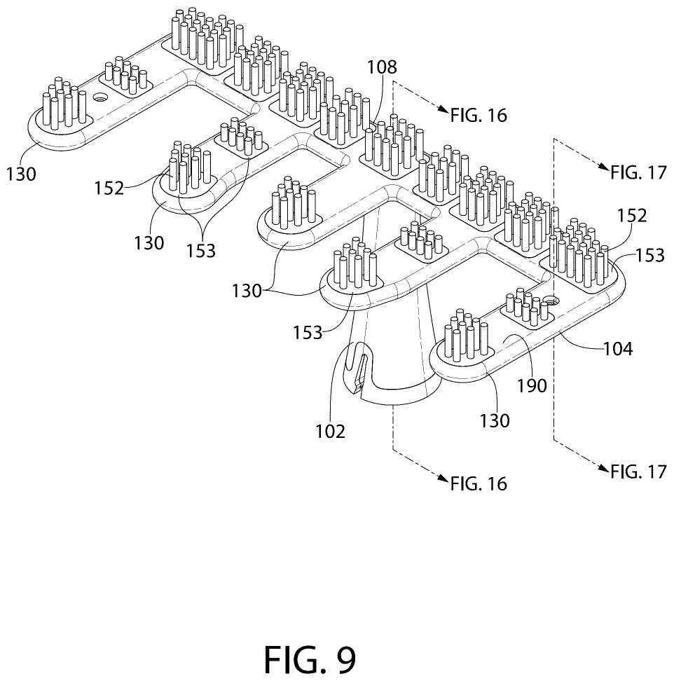

As best illustrated in FIGS. 9-17, the head portion 104 may be assembled to the neck portion 102 while the head portion is in a flat state. Manufacture of the head portion 104 prior to the flat state will be discussed in greater detail below. In the flat state, the wall 108 and fingers 130 are substantially planar. Thus, in the flat state, the head portion 104 is substantially planar. The head portion 104 is formed in subsequent states to achieve a fully bent state as illustrated in FIGS. 1-8. In the fully bent state, the head portion 104 is ready for use by an end user. The head portion 104 has a multi-component structure comprising a base structure 170, a plurality of tuft blocks 153 as discussed above, a plurality of bristle tufts 152 extending from each tuft block 153 as discussed above, a connector 114, and a guard structure 190.

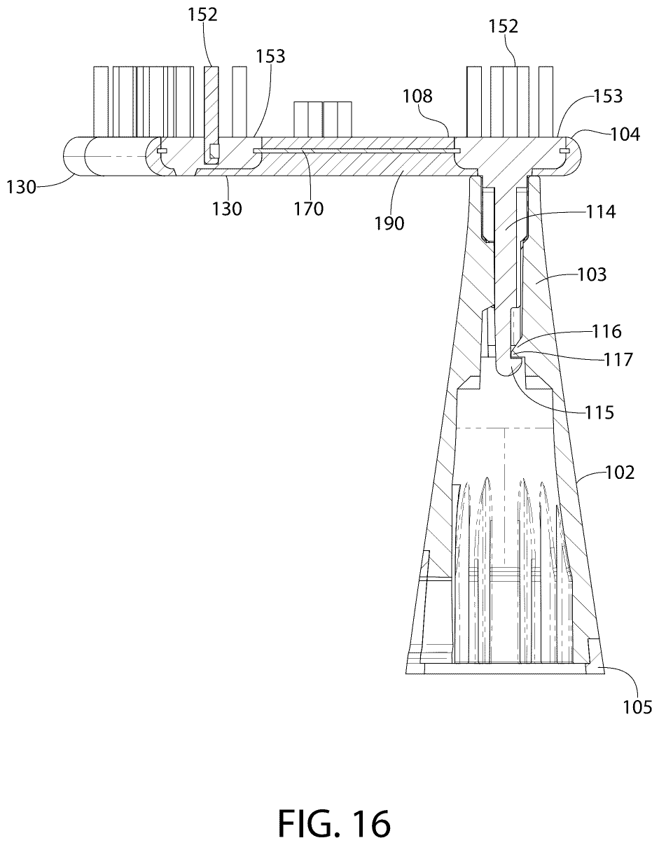

As best seen in FIG. 16, the head portion 104 is coupled to the neck portion 102 via a connector 114, the connector 114 being a part of the head portion 104 and engaging a corresponding connector 116 of the neck portion 102. Thus, the head portion 104 may be manufactured separately from the neck portion 102 and the head portion 104 may be assembled to the neck portion 102 by coupling the connector 114 of the head portion 104 to the connector 116 of the neck portion 102. The connectors 114, 116 may be a combination of hook and snap features, threaded, bolted, or other connection mechanisms. As can be seen, the connector 116 of the neck portion 102 comprises a protuberance 117 which engages a hook 115 of the connector 114 of the head portion 104. In other configurations the hook 115 and protuberance 117 may be switched. It is also contemplated that different arrangements of snap features may be utilized, with more than one hook or protuberance. In yet other optional configurations, the connectors 114, 116 may be omitted and the neck portion 102 may be directly attached to the head portion 104. The connectors 114, 116 may provide a permanent connection or may be detachably coupled.

Preferably, the connector 114 of the head portion is integrally formed with one of the tuft blocks 153. The connector 114 and the tuft block 153 forms a monolithic, integrally formed component. In other implementations, the connector 114 may be coupled to a tuft block 153 or the base structure 170 by heat staking, molding, mechanical fasteners, ultrasonic welding, or any other known process. Similarly, the connector 116 of the neck portion 102 is integrally formed with the neck portion 102, but may also be formed as a separate component. In the present embodiment, the connector 116 and a base structure 103 of the neck portion 102 are an integrally formed, monolithic component. An overmold component 105 is formed on the base structure 103.

The base structure 170 is preferably formed of a material suitable to permit plastic deformation such as bending in subsequent processing steps as will be discussed below. The material of the base structure 170 is selected to achieve the desired properties of the base structure 170. These properties may include vibration transmissibility, modulus of elasticity, acoustic impedance, mechanical impedance, or dynamic stiffness. It is desired that the base structure 170 be capable of transmitting vibrations efficiently while simultaneously being formable into the desired shape for brushing a user's teeth. The head portion 104 may take the form of a conventional toothbrush shape, a full or partial mouthpiece shape, or any other shape suitable for cleaning the user's oral cavity.

In one implementation, the base structure 170 is formed of a material having a higher vibration transmissibility than the material of the tuft blocks 153 or the guard structure 190. In another implementation, the base structure 170 is formed of a material having a higher modulus of elasticity than the material of the tuft blocks 153 or the guard structure 190. In another implementation, the base structure 170 is formed of a material having a higher acoustic impedance than the material of the sheet structure 150 or the guard structure 190. In yet another implementation, the base structure 170 is formed of a material having a higher mechanical impedance and dynamic stiffness than the material of the tuft blocks 153 or the guard structure 190.

Optionally, the base structure 170 may be formed of a metallic material, a metal, or any other material having relatively high vibration transmissibility. Preferably, the base structure 170 is formed of a steel such as a low carbon steel, a medium carbon steel, a spring steel, a stainless steel, or any other alloy principally comprising iron. Preferably, the base structure 170 is formed of a sheet metal such as sheet steel. The tuft blocks 153 may be optionally formed of a polymer material or other material suitable for receiving bristles or forming bristles thereon. The material of the tuft blocks 153 is preferably selected to optimize tuft retention or other features relating to mounting, coupling, or otherwise attaching tooth cleaning elements such as bristles. The material of the tuft blocks 152 may be acrylonitrile butadiene styrene (ABS), polyethylene terephthalate (PET), polybutylene terephthalate (PBT), nylon, polypropylene (PP), polyethylene naphthalate (PEN), polyethylene (PE), silicone, ethylene propylene diene monomer (EPDM), polycarbonate (PC), thermoplastic elastomers (TPE), and other plastics and elastomeric materials. Preferably, the tuft blocks 153 are formed of ABS, polypropylene, or another hard plastic rather than an elastomeric material.

As will be discussed below, the tuft blocks 153 are mounted, coupled, or otherwise joined to the base structure 170. Subsequently, the guard structure 190 is mounted, coupled, or otherwise joined to the base structure 170 and tuft blocks 153 as will be discussed in greater detail below. The guard structure 190 may be formed of an elastomeric material such as a thermoplastic elastomer, a rubber, or other flexible material which is resistant to plastic deformation.

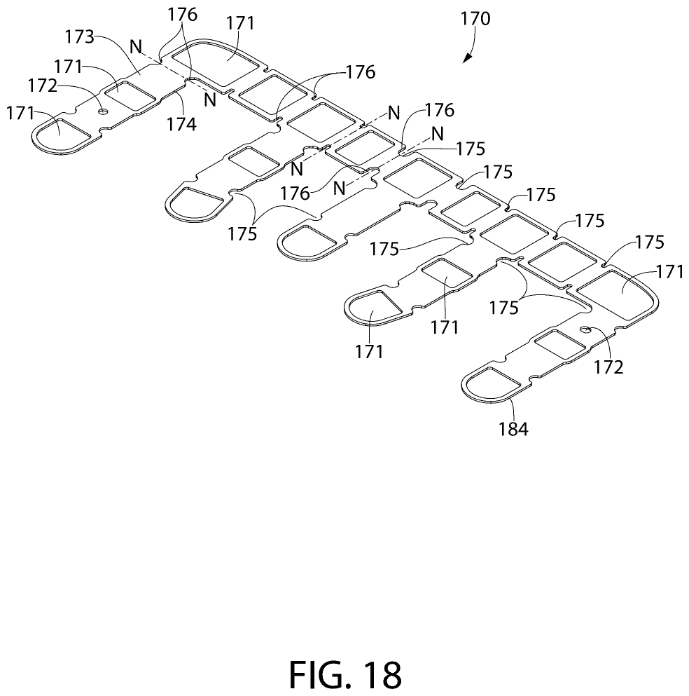

Turning to FIGS. 18-22A, the formation of the head portion is illustrated in greater detail. FIG. 18 illustrates the base structure 170 prior to addition of any other components. The base structure 170 is a substantially flat sheet having a plurality of apertures 171, 172 formed therein. The base structure 170 is preferably formed of steel or an alloy principally comprising iron. The base structure has a rear surface 174 which is opposite the front surface 173. A perimeter 184 extends from the front surface 173 to the rear surface 174. The front and rear surfaces 173, 174 are substantially planar prior to assembly with additional components which make up the head portion 104. However, embossed portions or other features may be added to provide structural strength, facilitate connection of one or more components, or for any other reason.

The apertures 171, 172 may include tooling or alignment apertures 172, the tooling or alignment apertures 172 used to position the base structure 170 during assembly and manufacturing of the head portion 104. The apertures 171, 172 may also include tuft block apertures 171. The tuft block apertures 171 may be formed with a single tuft block aperture 171 configured to receive a single tuft block 153. In other implementations, a plurality of tuft block apertures 171 may correspond to a single tuft block 153. The tuft block apertures 171 may be formed to allow passage of one or more tuft holes and corresponding bristle tufts 152 through the base structure 170. In other implementations, each tuft block aperture 171 may be formed to allow a single tuft hole and corresponding bristle tuft 152 to pass through the base structure 170. As illustrated, a single tuft block aperture 171 corresponds to a single tuft block 153, but other configurations are contemplated. Some exemplary alternate configurations will be discussed in greater detail below.

The base structure 170 may further incorporate a plurality of pre-weakened areas 175, these pre-weakened areas 175 located such that they are between adjacent tuft blocks 153 when the tuft blocks 153 are coupled to the base structure 170. Optionally, the pre-weakened areas 175 may be omitted. Where the pre-weakened areas 175 are provided, they may be a plurality of notches 176 as illustrated. These notches 176 may be located along an axis N-N, which defines a bend line for bending the base structure 170 to form bends and create the three-dimensional shape of the head portion 104. In other implementations, one or more apertures, grooves, slots, or other features may be utilized, either separately or in combination with the notches 176 to facilitate bending of the base structure 170 at the pre-weakened areas 175. The pre-weakened areas 175 may be utilized to promote bending of the base structure 170 at the desired locations. The notches 176 or other features which form the pre-weakened areas 175 may form a portion of the perimeter 184 of the base structure 170 or may be located within the perimeter 184 but not form a portion of the perimeter 184.

The notches 176 of the pre-weakened areas 175 may have different widths or depths. For instance, the notches 176 may increase or decrease in width, depth, or both with increasing distance from one of the apertures 171. The notches 176 may have square corners, radiused corners, or may terminate in an arcuate shape as illustrated in FIG. 18. Other embodiments of the notches 176 are illustrated in subsequent figures.

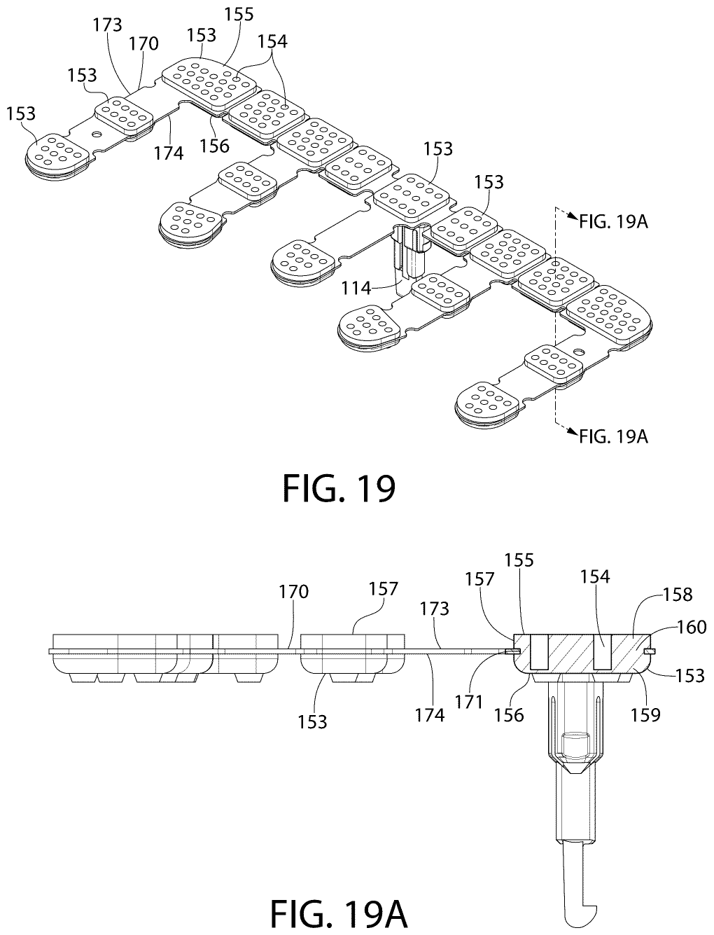

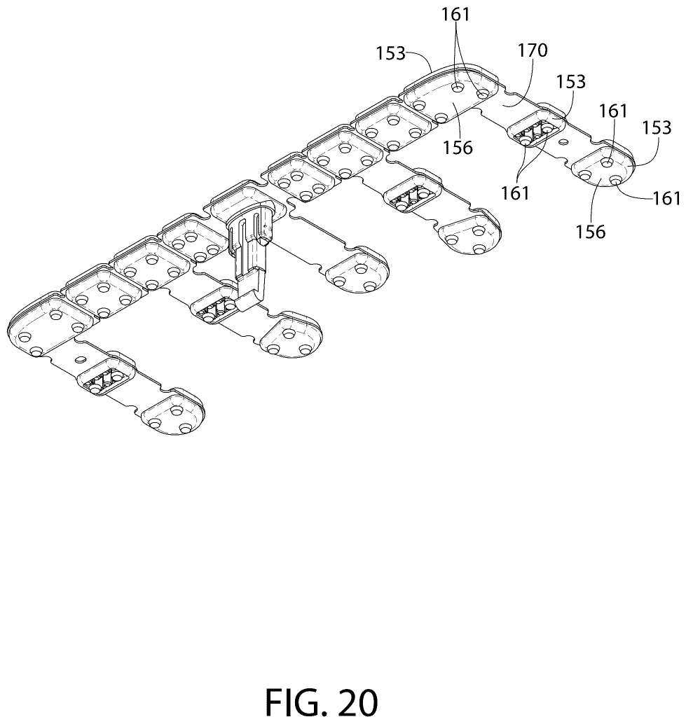

Turning to FIGS. 19, 19A, and 20, the plurality of tuft blocks 153 have been coupled to the base structure 170. The base structure 170 is still substantially planar during this stage of manufacture. Preferably, the tuft blocks 153 may be molded onto the base structure 170. In alternate configurations, the tuft blocks 153 may be glued, bonded, welded, or fastened to the base structure 170 using any known means. The tuft blocks 153 incorporate one or more tuft holes 154, the tuft holes 154 extending from a front surface 155 of the tuft blocks 153. The tuft blocks 153 also incorporate a rear surface 156. Generally, the tuft holes 154 do not extend through the tuft blocks 153 from the front surface 155 to the rear surface 156, instead terminating within the tuft blocks 153 as a blind hole. However, in some implementations the tuft holes 154 may extend through the tuft blocks 153 from the front surface 155 to the rear surface 156. The tuft holes 154 need not be exclusively circular, and may be rectangular, square, polygonal, oblong, or any other desired shape suitable to receive tooth cleaning elements such as bristle filaments. Multiple tuft hole shapes may be used on the same tuft block 153, or different shapes may be used on different tuft blocks 153 to achieve unique cleaning effects or varying bristle tuft densities.

A central one of the tuft blocks 153 further comprises the connector 114 of the head portion 104. The connector 114 and the central one of the tuft blocks 153 is an integrally formed, monolithic component. Thus, the central one of the tuft blocks 153 and the connector 114 are formed subsequent to formation of the base structure 170. In alternate configurations, the connector 114 may be fastened by heat staking, ultrasonic welding, fasteners, or any other known means.

FIG. 19A is a detail cross-section view showing a tuft block 153 and the base structure 170. The tuft blocks 153 have a perimeter 157 extending from the front surface 155 to the rear surface 156. As illustrated, the base structure 170 intersects the perimeter 157 of the tuft blocks 153. Thus, portions of the front and rear surfaces 173, 174 of the base structure 170 are covered by the tuft blocks 153 because the base structure 170 intersects the perimeter 157 of the tuft blocks 153. The tuft blocks 153 have a front portion 158, a rear portion 159, and a coupling portion 160. The front portion 158 extending from the front surface 155 of the tuft blocks 153 to the front surface 173 of the base structure 170. The front portion 158 is in contact with the front surface 173 of the base structure 170. The rear portion 159 in contact with and extending from the rear surface 174 of the base structure to the rear surface 156 of the tuft blocks 153. The coupling portion 160 extends through the apertures 171 of the base structure 170 from the front surface 173 to the rear surface 174. Thus, the coupling portion 160 connects the front portion 158 and the rear portion 159.

Optionally, the tuft holes 154 may extend through the apertures 171 of the base structure 170 as noted above. Optionally, the tuft holes 154 may also extend through the front portion 158 and the coupling portion 160. Thus, the tuft holes 154 may terminate within the rear portion 159. Alternately, the tuft holes 154 may terminate at the front surface 173 of the base structure 170, within the coupling portion 160, or within the rear portion 159. In yet other possible configurations, the tuft holes 154 may extend through the entirety of the tuft blocks 153 and through the apertures 171.

As illustrated in FIG. 20, the tuft blocks 153 may further incorporate a plurality of protuberances 161 extending from the rear surface 156. The plurality of protuberances 161 may extend from the rear portion 159. The plurality of protuberances 161 extend away from the front surface 155 of the tuft blocks 153. In other possible configurations, the base structure 170 may be located on the front surface 155 or rear surface 156 of the tuft blocks 153. In these configurations, the protuberances 161 may extend from the rear surface 155 of the tuft blocks 153. Optionally, the rear surface 155 may be formed on the coupling portion 160 or on the rear portion 159. Where the rear surface 155 is formed on the coupling portion 160, the rear portion 159 may be omitted. In this implementation, the rear surface 155 may be coplanar with the rear surface 174 of the base structure 170.

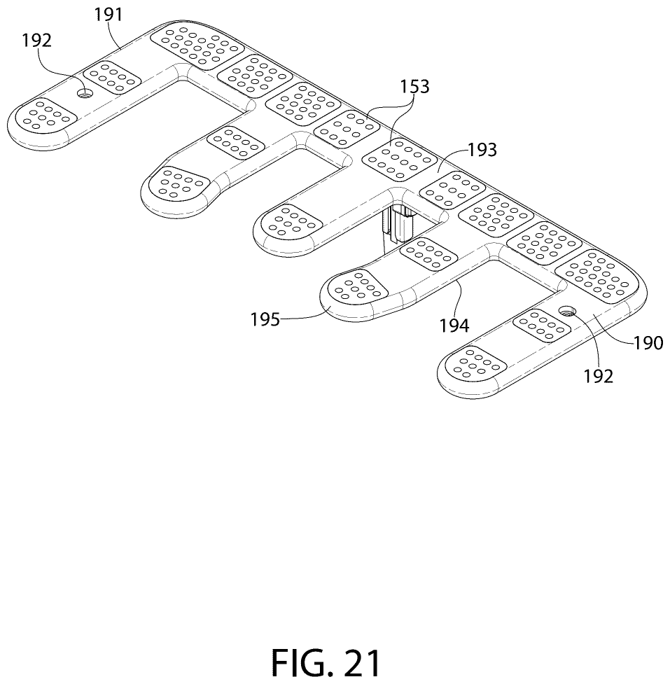

FIG. 21 illustrates the base structure 170 covered by the tuft blocks 153 and the guard structure 190. The combination of the base structure 170, tuft blocks 153, and guard structure 190 forms a head subassembly 120. The head subassembly 120 is substantially complete with the exception of installation of the bristle tufts 152. In some other implementations, some or all tooth cleaning elements may be formed prior to, concurrently with, or immediately subsequently to the formation of the guard structure 190. For instance, it is contemplated that some tooth cleaning elements may be integrally formed, monolithic, features of the guard structure 190.

Optionally, tooling apertures 192 may be formed in the guard structure 190, the tooling apertures being used to aid in subsequent positioning and alignment of the head subassembly 120 or the head portion 104. The tooling apertures 192 may be sized to allow access to the apertures 172 in the base structure 170. The tooling apertures 192 may be closed, covered, or plugged during a later step or left as is in the final product. In other implementations, the tooling apertures 192 may be omitted.

The guard structure 190 and the tuft blocks 153 preferably cover an entirety of the base structure 170. The guard structure 190 has an outer surface 191 comprising a front surface 193, a rear surface 194, and a perimeter surface 195. The perimeter surface 195 extends around the wall 108 and fingers 130 of the head portion 104. The front surface 193 is substantially coplanar with the front surface 155 of the tuft blocks 153 while the rear surface 194 covers the rear surface 156 of the tuft blocks 153. Thus, the front surface 193 of the guard structure 190 and the front surface 155 of the tuft blocks 153 are flush at an interface between the guard structure 190 and the tuft blocks 153. The guard structure 190, in combination with the tuft blocks 153, encapsulate the guard structure 170. The perimeter surface 195 is spaced from an edge of the base structure 170. Preferably, the protuberances 161 terminate in a surface that is substantially coplanar and flush with the rear surface 194 of the guard structure 190. The protuberances 161 may be any number, and in some configurations some of the protuberances 161 may also serve as cleaning or massaging elements that extend beyond the rear surface 194 of the guard structure 190.

The guard structure 190 may be constructed from sheet material or it may be a molded component which is either molded separately or over molded onto the base structure 170 and the tuft blocks 153. In certain embodiments, the guard structure 190 may be formed, at least in part, of a biocompatible material, such as a food grade polymer. Suitable biocompatible materials include, without limitation, acrylonitrile butadiene styrene (ABS), polyethylene terephthalate (PET), polybutylene terephthalate (PBT), nylon, polypropylene (PP), polyethylene naphthalate (PEN), polyethylene (PE), silicone, ethylene propylene diene monomer (EPDM), polycarbonate (PC), thermoplastic elastomers (TPE), and other plastics and elastomeric materials. Of course, the invention is not to be so limited in all embodiments and other materials are possible for construction of the guard structure 190, and various components thereof. In certain embodiments, the guard structure 190, or at least portions thereof, may be formed of an elastomeric material. A hybrid construction including components having different materials is contemplated.

Optionally, the guard structure 190 may be overmolded onto the base structure and tuft blocks 153. Alternately, the guard structure 190 may be formed separately and bonded, welded, or otherwise joined to the base structure 170 and tuft blocks 153. It is contemplated that the guard structure 190 may be a single, monolithic, component formed of an elastomeric material or that it may be formed as two or more components which are subsequently joined to encapsulate the base structure 170 and surround the tuft blocks 153.

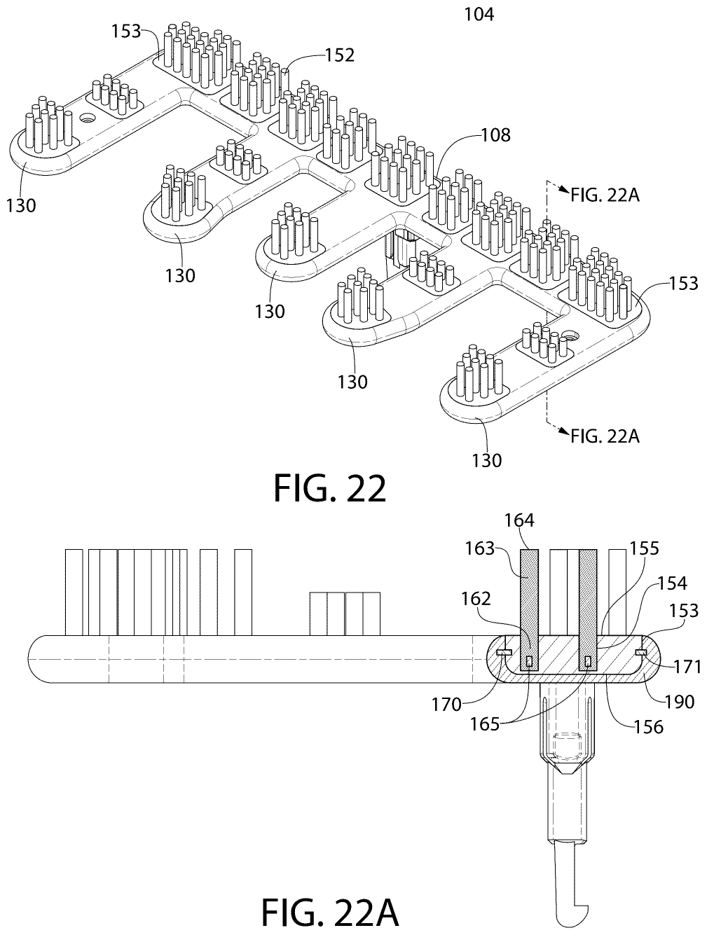

FIG. 22 shows the head portion 104 in the flat state subsequent to installation of the bristle tufts 152. The flat state is, as illustrated, a state where the head portion 104 is not bent into its final shape. The head portion 104 is substantially planar when in the flat state, with the fingers 130 and the wall 108 lying in a single plane. The head subassembly 120 is converted into a head portion 104 in the flat state by installing bundles of bristle filaments into the tuft holes 154 to form the bristle tufts 152. Optionally, a variety of tuft methods may be utilized, including anchored or stapled bristle tufts 152, anchor free tufting (“AFT” tufting), in mold tufting, “AMR” anchorless tufting, pressure-time-temperature (“PTt” tufting), or any other known processes. During tufting, the

As seen in FIG. 22A, each of the bristle tuft bundles 164 which form the plurality of bristle tufts 152 has a base portion 162 and a free portion 163. The base portion 162 is inserted within a respective one of the plurality of tuft holes 154 while the free portion 163 extends from the front surface 155 of the tuft blocks 153. Thus, the free portion 163 serves to clean the user's teeth while the base portion 162 is used to secure the bristle tuft filaments within the tuft holes 154. The base portions 162 may extend through the apertures 171 in the base structure 170, ensuring sufficient depth for adequate retention. As illustrated, an anchor 165 such as a staple may be used to anchor the bristle tuft bundles 164 within the tuft holes 154. In other embodiments, the anchor 165 may be omitted.

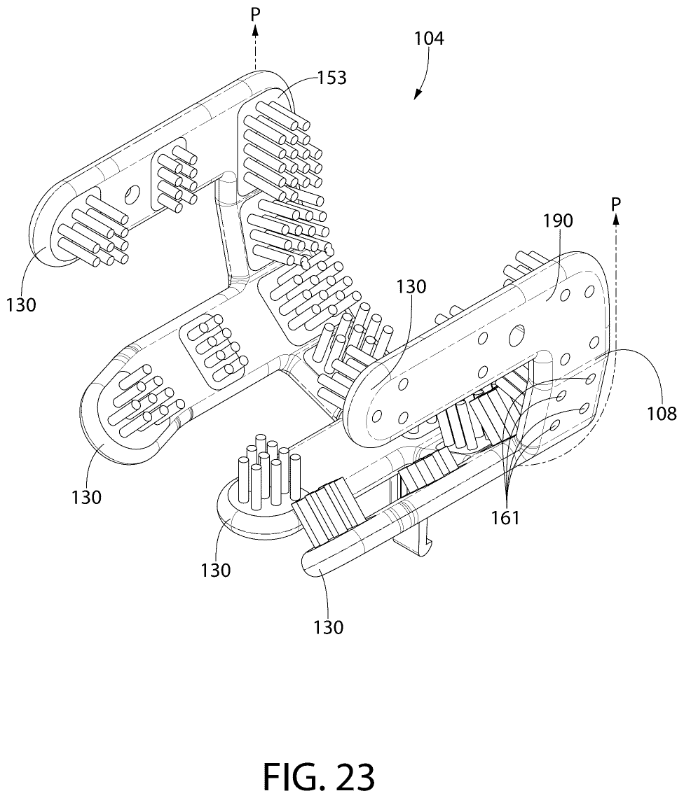

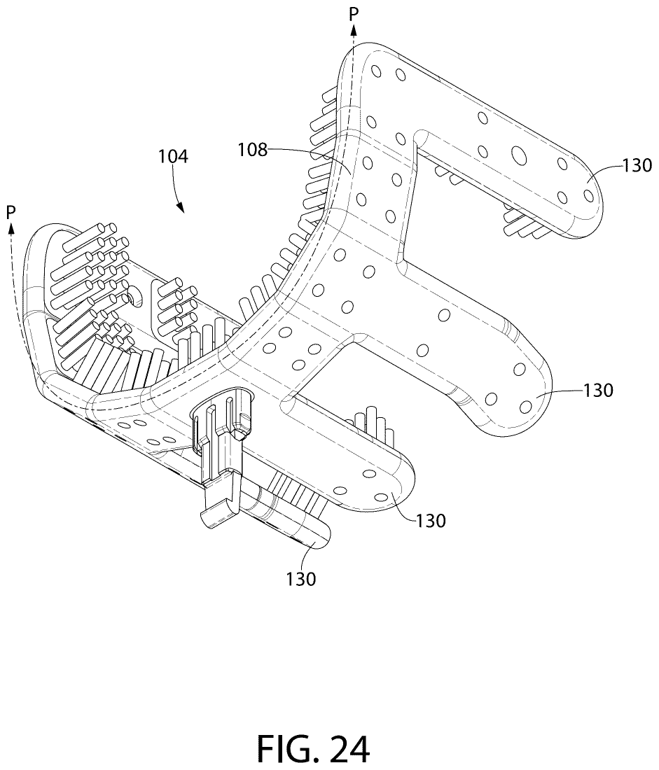

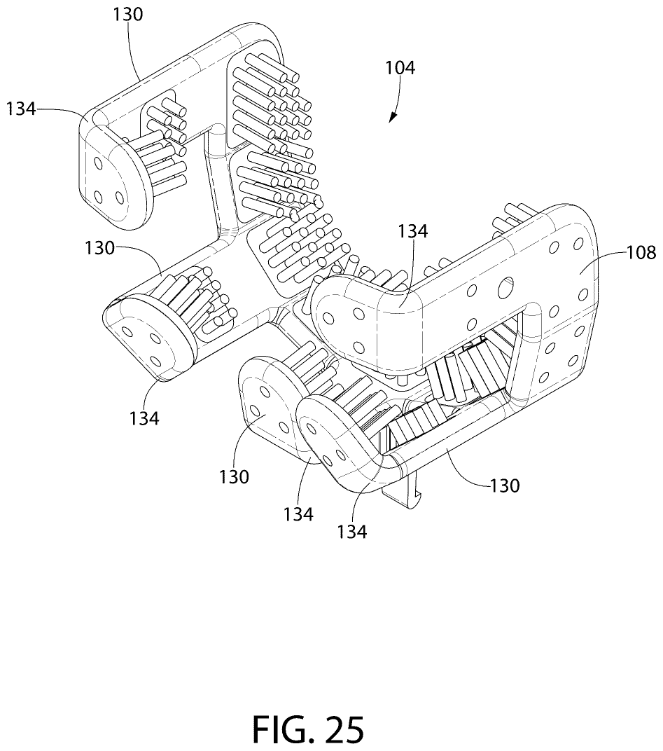

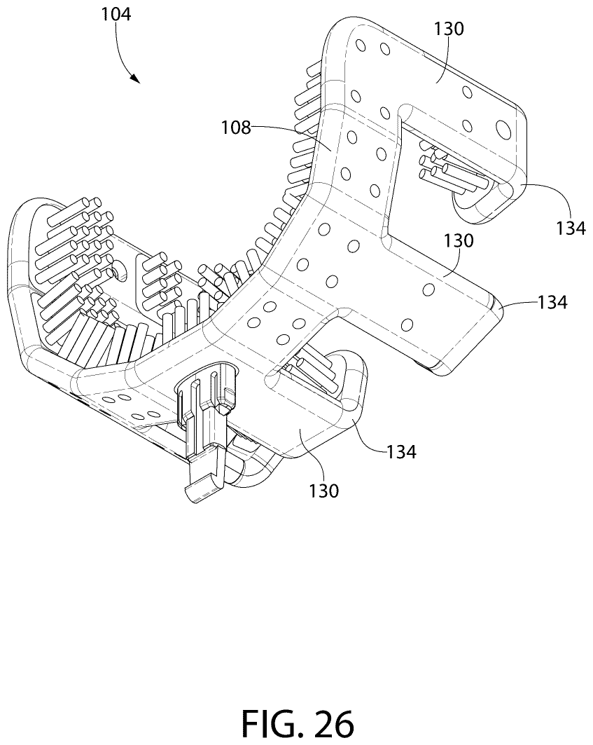

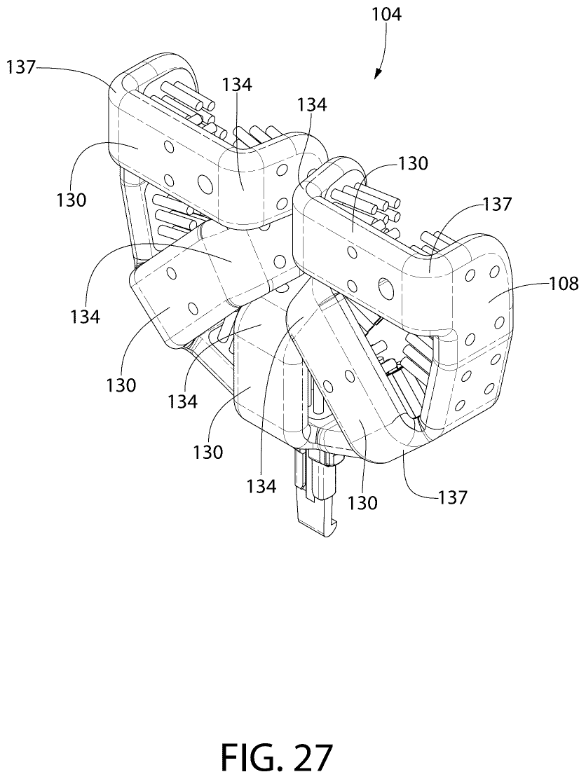

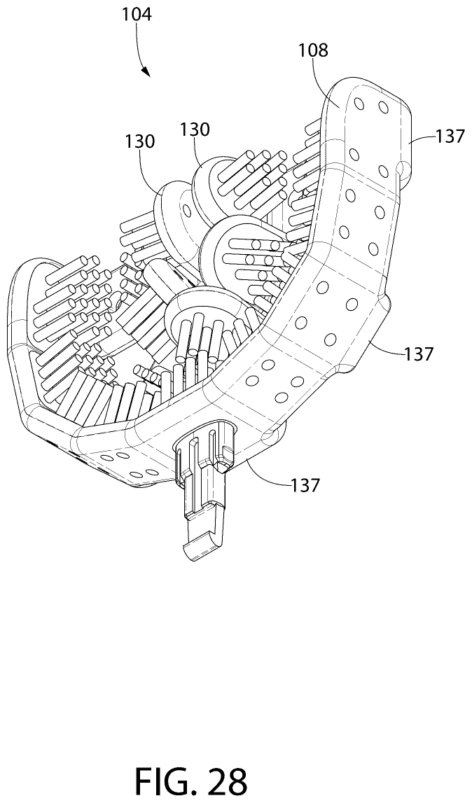

As noted above, FIG. 22 illustrates the head portion 104 in a flat state where the head portion 104 lies in a plane. FIGS. 23 and 24 illustrate the head portion 104 in a first partially bent state where the head portion 104 no longer extends along a plane. Instead, the head portion 104 has been bent to begin forming the head portion 104 into its final state by bending the wall 108 along the path P-P. FIGS. 25 and 26 illustrate the head portion 104 in a second partially bent state where the fingers 130 of the head portion 104 are partially bent at the first bend 134. FIGS. 27 and 28 illustrate the head portion 104 in a fully bent state, with the fingers are bent at the second bend 137. After transitioning from the flat state to the fully bent state, the head portion 104 is ready for assembly with the neck portion 102 and use by an end user.

In the first partially bent state shown in FIGS. 23 and 24, the wall 108 of the head portion 104 has been bent about the path P-P. As noted above, the path P-P may be an arc, a series of arcs, a combination of arcs and lines, or any other shape as desired. The path P-P may be designed to conform to a user's dental arch or an approximation thereof. The wall 108 of the head portion may be bent simultaneously, or may be bent by making a series of smaller bends in succession. In either case, the wall 108 is plastically deformed to achieve the desired shape. Specifically, the base structure 170 is plastically deformed. As can be seen, the fingers 130 extend perpendicular to the path P-P and remain un-bent in the first partially bent state. In addition, it can be seen that the protuberances 161 of the tuft blocks 153 are exposed through the guard structure 190.

In the second partially bent state shown in FIGS. 25 and 26, the fingers 130 of the head portion 104 are bent at a first bend 134 proximate a distal end of the fingers 130. Thus, the fingers 130 have been bent once, such that the fingers 130 no longer extend exclusively perpendicular to the path P-P. The first bends 134 of the fingers 130 need not be bent at the same angle. Instead, the bend angles may differ for each of the first bends 134 of the fingers 130. In yet other possible configurations, some of the fingers 130 may remain un-bent in the second partially bent state, with only a portion of the fingers 130 being bent.

FIGS. 27 and 28 illustrate the head portion 104 in a fully bent state. In the fully bent state, the fingers 130 are bent at a second bend 137, the second bend adjacent the wall 108. Thus, the fingers 130 are preferably bent at first and second bends 134, 137. The fingers 130 and the wall 108 collectively form an arcuate channel which is configured to receive at least a portion of a user's dental arch. The arcuate channel need not be continuous, instead being formed via the series of fingers 130 to allow relative motion between the fingers 130 and ensure that the head portion 104 can conform to the user's dental arch without a need for custom fitting or design for each and every user. Each finger 130, in combination with a portion of the wall 108, forms a u-shaped channel. Collectively, the plurality of fingers 130 and the wall 108, form the arcuate channel from the u-shaped channels.

In the fully bent state, the fingers 130 form an L shape, with the first bend 134 not necessarily 90 degrees. Similarly, the second bend 137 may be other than 90 degrees as desired. The illustrated embodiment shows the second bend 137 at approximately 90 degrees, but other angles are contemplated. The second bends 137 may be at different angles if desired, allowing variation in the formation of the fingers 130 and the resulting u-shaped channels.

In the fully bent state, the head portion 104 can be coupled to the neck portion 102. Then the head 100 is ready for use by the user. In other implementations, the head portion 104 may have upper and lower arcuate channels suitable to engage both upper and lower dental arches simultaneously. In such implementations, the fingers 130 may be bent such that they extend in different directions. In other implementations, the wall 108 may be discontinuous, such that there is an inner wall and an outer wall. The inner wall and outer wall may be coupled by one or more fingers 130, allowing greater flexibility over the placement of cleaning elements on both inner and outer dental arches.

In some implementations, the fingers 130 may be bent prior to bending of the wall 108 along the arcuate path P-P. In other implementations, the fingers 130 may be bent subsequent to the bending of the wall 108. In yet other implementations, the fingers 130 may be bent simultaneously with the wall 108. The sequence of bending of the fingers 130 and the wall 108 may vary as desired.

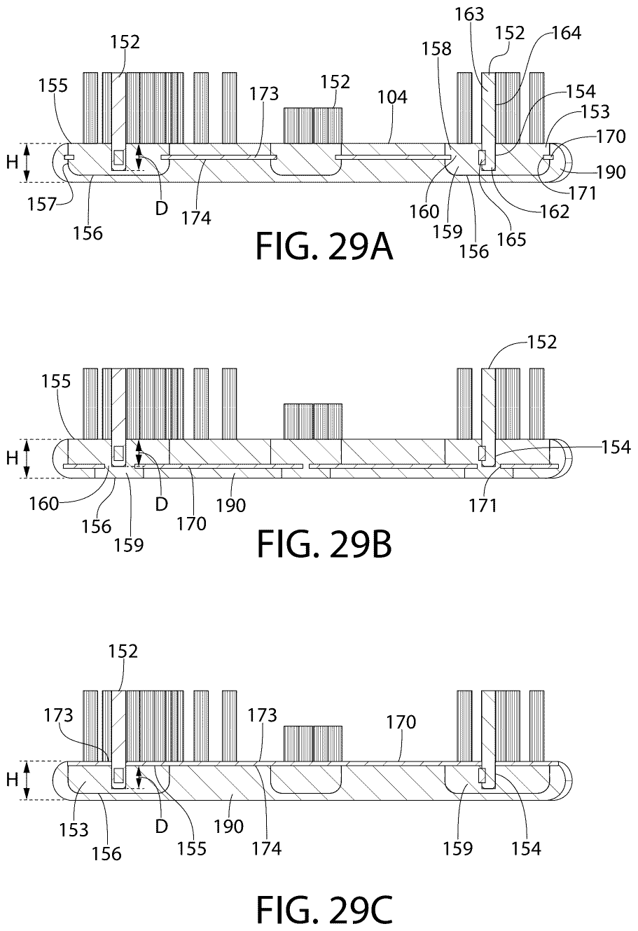

Turning to FIGS. 29A-C, several schematic cross-sections are shown, each of these figures illustrating alternate configurations of the components forming the head portion 104. FIG. 29A illustrates the configuration illustrated in FIGS. 1-28. FIGS. 29B and 29C illustrate other alternate configurations. FIG. 29A has a plurality of bristle tufts 152 formed of bristle tuft bundles 164 of bristle filaments which are inserted into tuft holes 154 formed in tuft blocks 153. The tuft blocks 153 have a front surface 155, a rear surface 156, and a perimeter 157 extending from the front surface 155 to the rear surface 156. The tuft blocks 153 also have a height H extending from the front surface 155 to the rear surface 156. The base structure 170 has apertures 171, the tuft holes 154 extending through the apertures 171 but not extending through an entirety of the tuft blocks 153. The tuft holes 154 have a depth D which is less than the height H of the tuft blocks 153. Anchors secure base portions 162 of the bristle tuft bundles 164 into the tuft holes 154 while the free portions 163 of the bristle tuft bundles 164 extend from the front surface 155 of the tuft blocks 153.

The guard structure 190 surrounds the perimeters 157 and rear surfaces 156 of the tuft blocks 153 and the front and rear surfaces 173, 174 of the guard structure 170. The guard structure 170 intersects the perimeters 157 of the tuft blocks 153 at the coupling portions 160 of the tuft blocks 153, with the front portions 158 extending from the coupling portions 160 to the front surfaces 155. The rear portions 159 of the tuft blocks 153 extend from the coupling portions 160 to the rear surfaces 156. The tuft blocks 153 are exposed on the front surfaces 155 but not on the rear surfaces 156. The protuberances 161 are not shown in this schematic view, but are exposed as shown in other figures.

FIG. 29B illustrates an embodiment where the rear surfaces 156 of the tuft blocks 153 may also be exposed. Thus, the protuberances 161 are omitted, with the rear surface 156 and front surface 155 exposed through the guard structure 190. The tuft blocks 153 have a height H extending from the front surface 155 to the rear surface 156. The tuft hole 154 extends into the aperture 171 without extending through the apertures 171. The tuft hole 154 terminates in the coupling portions 160 rather than the rear portions 159 and has a depth D which is less than the height H. This configuration may allow a reduced height of the head portion 104 as compared with the embodiment of FIG. 29A, which is desirable for improved user experience. In yet other variations, the tuft holes 154 may terminate without extending into apertures 171 of the base structure 170. Thus, it is contemplated that the apertures 171 may be omitted or have no correlation with the arrangement of the tuft holes 154.

FIG. 29C illustrates an embodiment where the guard structure 170 is in direct surface contact with the front surface 155 of the tuft blocks 153. Specifically, the rear surface 174 of the guard structure 170 is in direct surface contact with the front surface 155 of the tuft blocks 153. The tuft holes 154 extend through the apertures 171. The tuft blocks 153 do not have a front portion or a coupling portion, only a rear portion 159. The rear surface 156 may be covered by the guard structure 190 or exposed, as desired. The tuft blocks 153 have a height H which is less than a depth D of the tuft holes 154. The tuft holes 154 terminate before the rear surface 156 and do not extend through the tuft blocks 153. The front surface of the head portion 104 is formed by the guard structure 170.

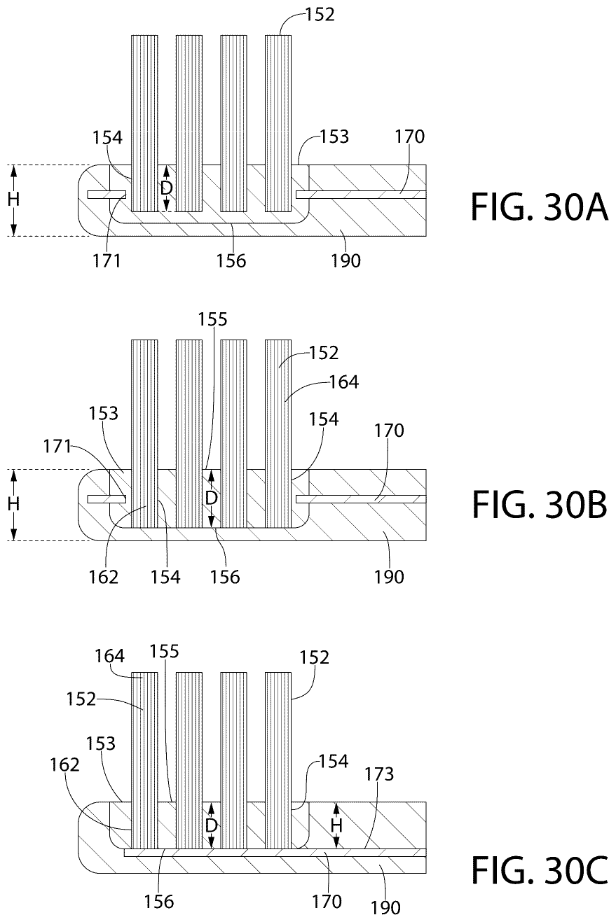

FIGS. 30A-30C illustrate yet further optional configurations. FIG. 30A illustrates an embodiment where the tuft hole 154 extends through the aperture 171 of the base structure, but does not extend through an entirety of the tuft block 153. The tuft block 153 has a height H and the tuft hole 154 has a depth D which is less than the height H. This allows use of traditional tufting processes with good tuft retention and minimal thickness of the head portion 104. The guard structure 190 covers the rear surface 156 of the tuft block 153.

FIG. 30B illustrates an embodiment where the tuft holes 154 extend through an entirety of the tuft block 153. Thus, the tuft holes 154 extend from the front surface 155 to the rear surface 156 of the tuft blocks 153 and have a depth D which is equal to a height H of the tuft blocks 153. The bristle tufts are installed such that the base portions 162 of the bristle tuft bundles 164 are in contact with the guard structure 190. The tuft holes 154 extend through the apertures 171 of the base structure 170, the base structure 170 intersecting the perimeter 157 of the tuft block 153. This further reduces the height of the head portion 104 over the embodiment of FIG. 30A.

FIG. 30C illustrates an embodiment where the tuft holes 154 extend through an entirety of the tuft block 153, from the front surface 155 to the rear surface 156. Thus, a depth D of the tuft holes 154 is equal to a height H of the tuft block 153. The bristle tuft bundles 164 are inserted into the tuft holes 154 such that the base portions 162 are in surface contact with the base structure 170. Apertures may be omitted from the base structure 170, and the tuft block 153 does not extend through the base structure 170. Instead, the front surface 173 of the base structure 170 is in direct surface contact with the rear surface 156 of the tuft block 153. This allows the tuft holes 154 to be independent of any apertures formed in the base structure 170 while minimizing height of the head portion 104.

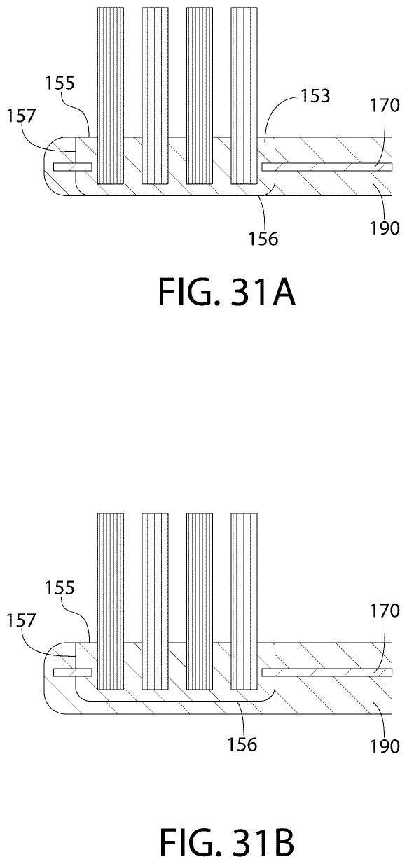

FIGS. 31A and 31B illustrate different ways of applying the guard structure 190 to the tuft blocks 153 and the base structure 170. In FIG. 31A, the guard structure 190 surrounds the perimeter 157 of the tuft blocks 153 while leaving the front and rear surfaces 155, 156 exposed. Thus, the guard structure covers the base structure 170 but only surrounds the tuft blocks 153. In FIG. 31B, the guard structure 190 surrounds the base structure 170 and the rear surface 156 of the tuft blocks 153. The guard structure 190 also surrounds the perimeter 157 of the tuft blocks 153, leaving the front surface exposed. In this embodiment, protuberances are omitted such that the guard structure completely covers the tuft blocks 153 excepting the exposed front surface 155.

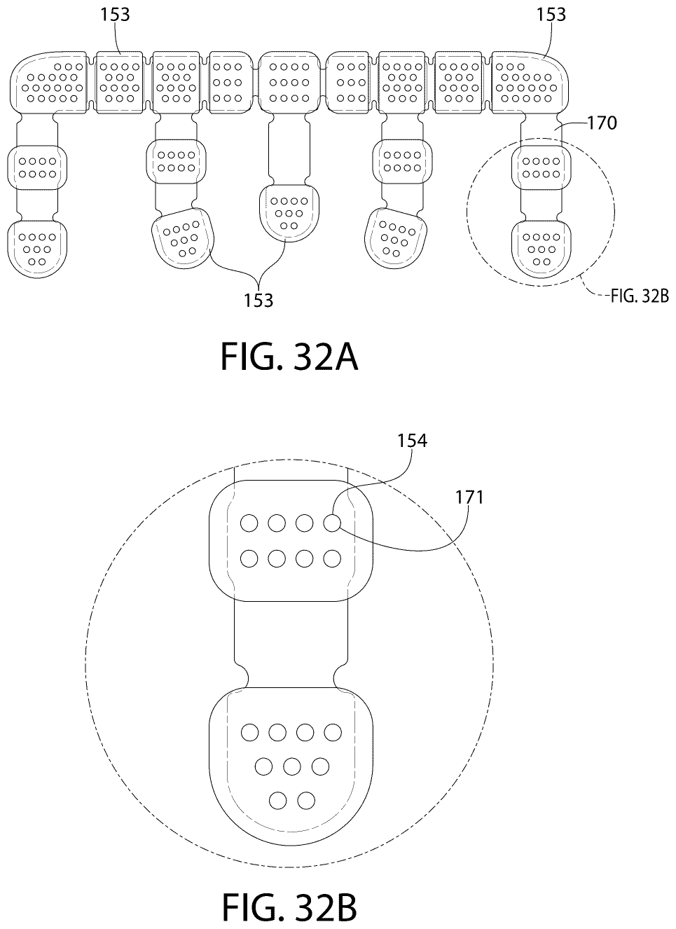

FIGS. 32A and 32B illustrate another embodiment of the base structure 170 and tuft blocks 153. In this embodiment, the guard structure 170 has a plurality of apertures 171, with each aperture 171 corresponding to a tuft hole 154 of one of the tuft blocks 153. In other words, each tuft hole 154 and each aperture 171 have a one to one pairing, with every tuft hole extending through a different aperture 171. This allows increased strength of the base structure 170. The apertures 171 may be the same size as the tuft holes 154 or the apertures 171 may be larger than the tuft holes 154. Where the apertures 171 are larger than the tuft holes 154, material of the tuft blocks 153 extends through the apertures 171.

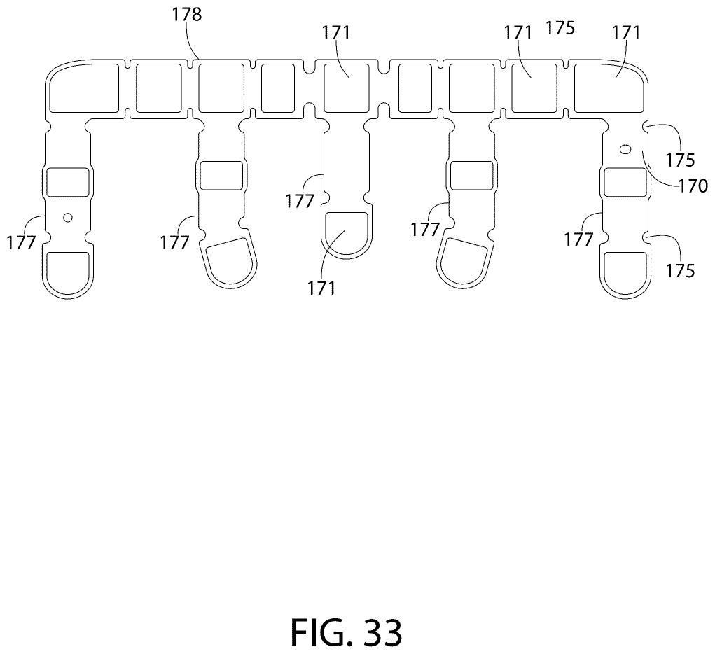

FIG. 33 shows a guard structure 170 where an open contour is used for the apertures 171. The guard structure 170 has a single aperture 171 corresponding to each tuft block 153. This beneficially allows flexibility in tuft placement. It is contemplated that some or all tuft holes 154 extend through the apertures 171. However, it is also possible that some tuft holes 154 may be located outside the guard structure 170 and do not extend through an aperture 171. Furthermore, it is contemplated that the guard structure 170 may incorporate slots having an open perimeter contour, these slots also receiving some tuft holes 154. Thus, a wide variety of tuft hole arrangements may be used. In addition, it is contemplated that pre-weakened areas 175 may be formed at any locations where a bend will be made. For instance, finger portions 177 and a wall portion 108 may incorporate pre-weakened areas 175. In other implementations, the pre-weakened areas 175 may be eliminated at the location of certain bends to achieve different bends, different strengths at the bend, or other reasons that facilitate formation of the desired head portion 104.

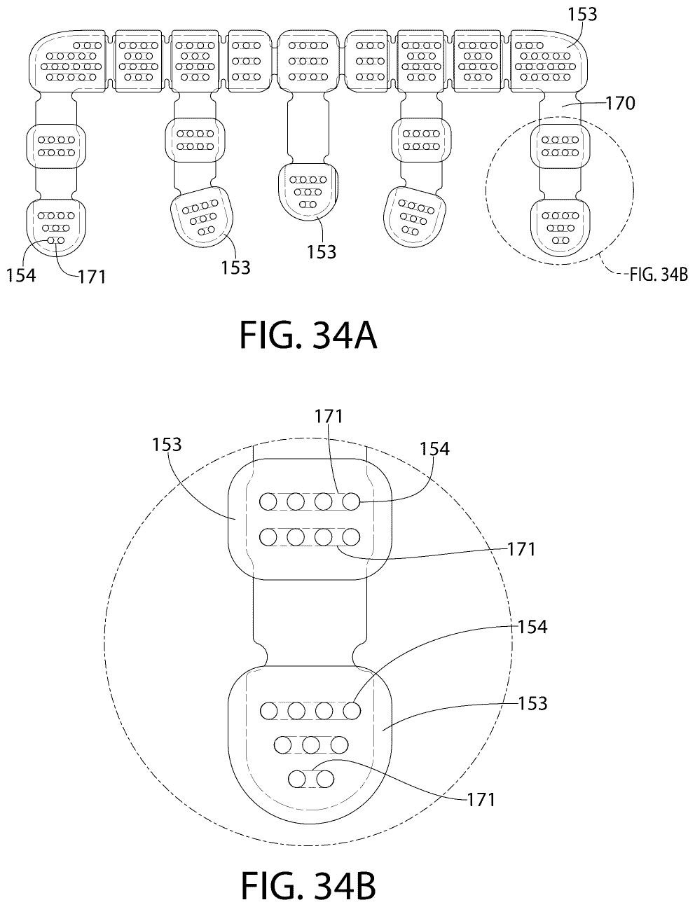

Turning to FIGS. 34A and 34B, another embodiment of the guard structure 170 is shown with tuft blocks 153 formed thereon. The guard structure 170 incorporates a plurality of apertures 171, with the apertures 171 being elongate. A plurality of tuft holes 154 are located within some or all of the apertures 171. This has the benefit of a greater volume of material of the tuft blocks 153 extending through the apertures 171 and some flexibility of the placement of tuft holes 154 without a need to alter the base structure 170. In addition, it allows increased material of the base structure 170, increasing the strength of the base structure 170 at the tuft blocks 153.

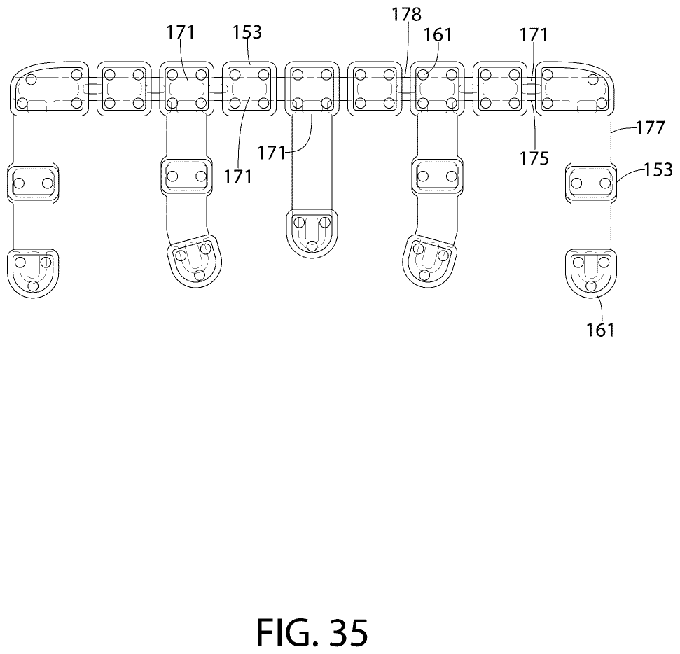

FIG. 35 illustrates another embodiment of the base structure 170 wherein the finger portions 177 and the wall portion 178 have a plurality of apertures 171. It should be noted that in this illustration, the tuft holes are omitted for clarity. The apertures 171 are arranged both for passage of bristle tufts therethrough and also as features which create the pre-weakened areas 175. Notably, locations where the base structure will be bent in subsequent operations do not all incorporate pre-weakened areas 175. Near the center of the wall portion 178, no apertures 171 are present. Moving outward from the center, the apertures 171 at the pre-weakened areas increase in size to reduce the stiffness and the spring constant or spring rate for each bend location. Thus, the guard structure 170 may have a configuration whereby different bend locations have differing stiffness or resistance to bending. This can beneficially control the deflection of the head portion 104 so that excessive deflection does not occur in specific areas of the head portion 104. The protuberances 161 are also illustrated, the protuberances 161 extending from the rear surface of the tuft blocks.

In addition to the embodiment of FIG. 35, each and every one of the embodiments will have a spring rate at each of the bends 118 of the wall 108 and the first and second bends 134, 137 of the fingers 130. This spring rate is measured as an amplitude of force required to achieve a specific unit of deflection. For instance, the spring rate may be measured as a linear distance of deflection or an angular distance of deflection for a given force. It is contemplated that some of the spring rates or stiffnesses may vary, or that all of the spring rates may be identical. Different spring rates may be selected to achieve different deflection characteristics across the entirety of the head portion 104. For instance, bends 118 adjacent the connector 114 may have a higher spring rate and resistance to deflection than bends 118 located further from the connector 114.

Furthermore, the spring rate of the segments 119 may have a higher spring rate than the bends 118. Optionally, the spring rate of the segments 119 may be higher than all bends 118 or only higher than adjacent ones of the bends 118. The spring rate may be determined from a combination of the stiffnesses or spring rates of the base structure 170, tuft blocks 153, and guard structure 190. Generally, it is contemplated that the base structure 170 and tuft blocks 153 make the largest contribution to the spring rate or stiffness of the segments 119, while the bends 118 have a spring rate or stiffness determined by a combination of the base structure 170 and the guard structure 190. The base structure 170 generally provides the greatest contribution to the stiffness of the bends 118 and segments 119. In some implementations, the tuft blocks 153 may provide a greater contribution to the spring rate or stiffness of the segments 119 than the guard structure 170.

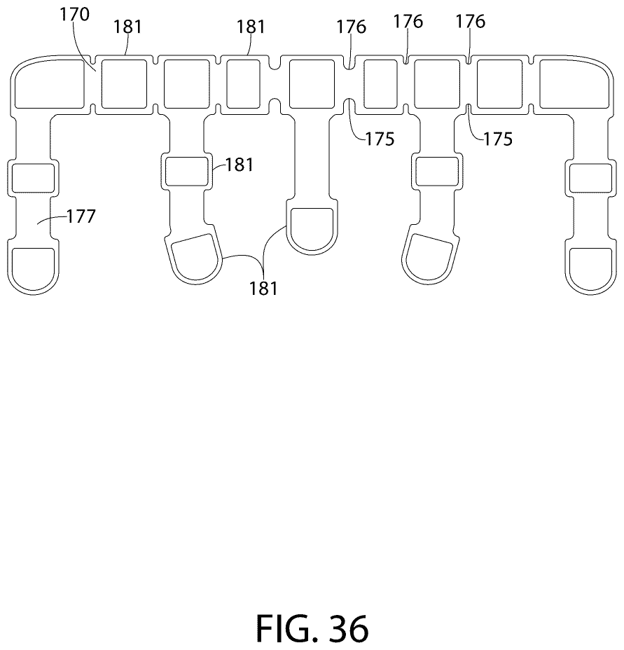

Turning to FIG. 36, another embodiment of the base structure 170 is illustrated with notches 176 formed at pre-weakened areas 175 between locations for tuft blocks 153. The notches 176 may vary in depth and width to achieve variations in stiffness of the base structure 170 as mentioned above. Total stiffness is determined from the shape and material of the tuft blocks 153, the base structure 170, and the guard component 190. The primary contributor to stiffness is the base structure 170, so changes to this component has the greatest impact on the stiffness of the head portion 104. As can be seen, the finger portions 178 may be narrower between tuft block locations 181 rather than having notches 176. This may result in a more consistent stiffness or spread deflection over a greater area of the base structure.

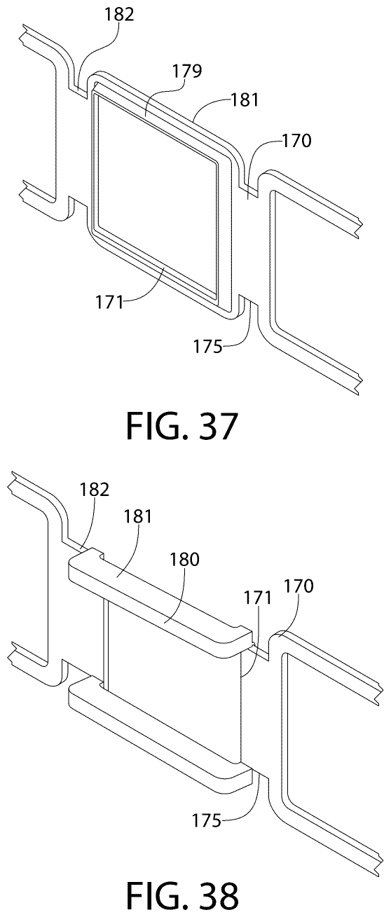

FIGS. 37 and 38 illustrate some alternate means of increasing stiffness of the tuft block locations 181. An embossed feature 179 may surround the apertures 171 to increase the stiffness relative to the pre-weakened areas 175 or other bend locations 182. In other possible arrangements, ribs 180 may be formed by bending the base structure 170. This will also aid in increasing stiffness of the tuft block location 181 between bend locations 182. The ribs 180 and embossed features 179 may be formed via any stamping, bending, or metal forming technique, but add a raised or bent feature which locally increases stiffness of the base structure 170, raising the spring rate.

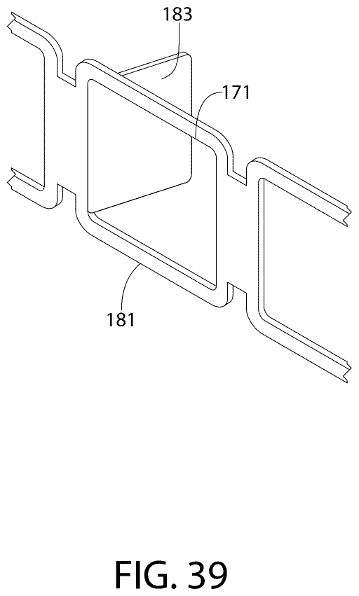

FIG. 39 illustrates a flange 183 which is formed from material removed when forming a central one of the apertures 171 at a central one of the tuft block locations 181. The flange 183 may be used to increase mechanical strength between the connector 114 of the head portion 104 and the base structure 170 by overmolding, screwing, heat staking, or otherwise joining the flange 183 to the connector 114. This may be useful for ensuring that the connector 114 has sufficient strength to endure abnormal use conditions without failure.

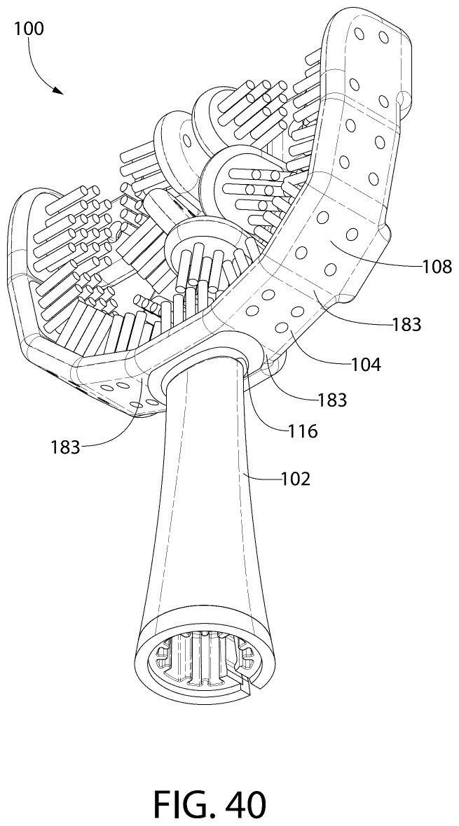

Finally, FIG. 40 illustrates a perspective view of an alternate construction of the head 100. The connector 116 of the neck portion 102 extends beyond first and second ones of the plurality of bends 183 in the wall 108. The first and second bends 183 are located on opposite sides of a central tuft block 153. The connector 116 is in direct surface contact with the first and second bends 183 and increases the stiffness or spring rate of the first and second bends 183. This increase in stiffness goes beyond what can be achieved by modifications to the base structure 170 alone. Once again, the connector 116 of the neck portion 102 may be coupled to the connector 114 of the head portion 104 via a snap fastener or similar snap features.

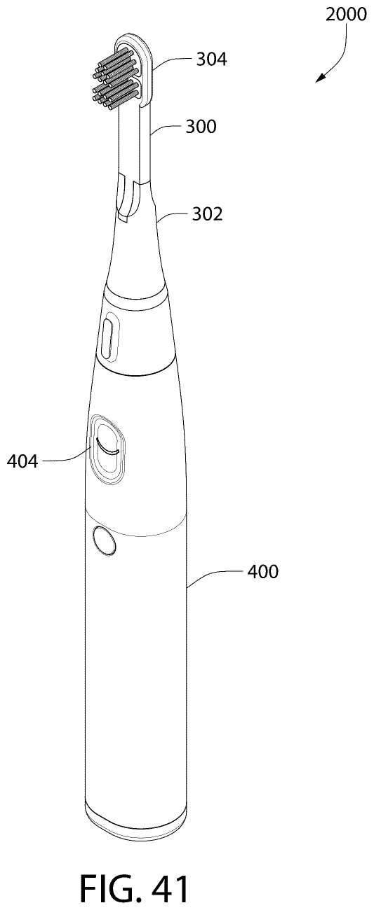

FIG. 41 illustrates another embodiment of an oral care implement 2000. The oral care implement 2000 is a powered device for cleaning a user's teeth and other oral tissues. The oral care implement 2000 is arranged similarly to a conventional toothbrush and has a head 300 and a handle 400, the head 300 having a neck portion 302 and a head portion 304. The handle 400 has a vibration generating device and a user interface 404 configured to control operation of the vibration generating device. The vibration generating device is preferably a motor, but may be any known type of vibration generating device suitable for transmitting vibrations from the handle 400 to the head 300 to excite cleaning elements on the head 300. Optionally, the head 300 may be detachably coupled to the handle 400 or it may be permanently coupled. In yet other variations, the oral care implement 2000 may be an unpowered or manual toothbrush, with cleaning action provided by the user moving the cleaning elements against the user's teeth.

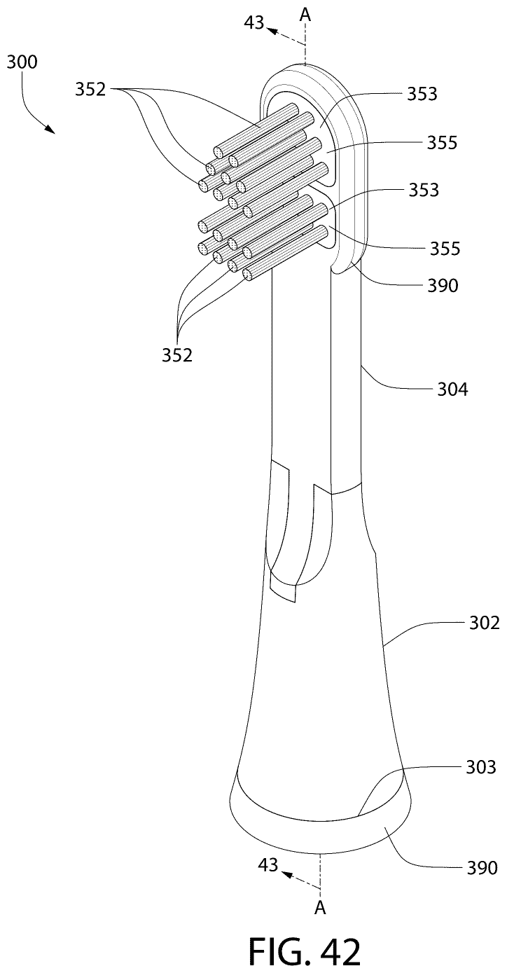

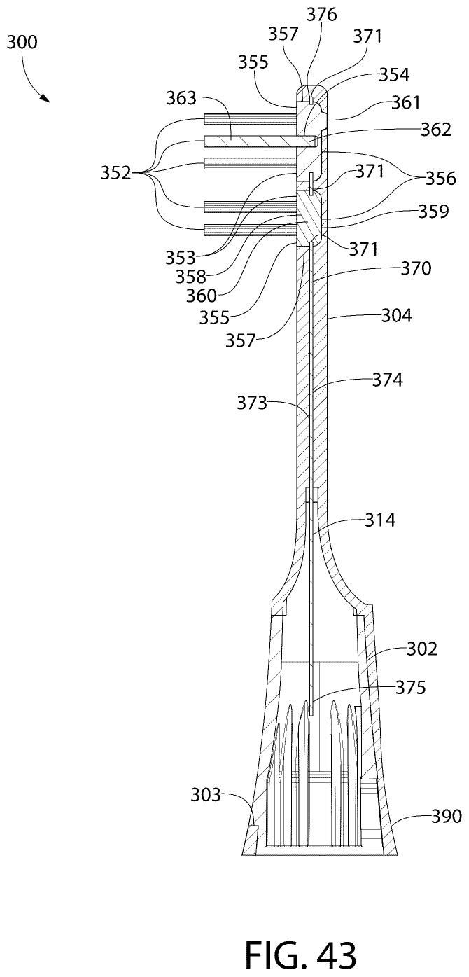

FIGS. 42 and 43 illustrate the head 300 in greater detail. As discussed above, the head 300 has a head portion 304 coupled to a neck portion 302. The neck portion 302 may engage a stem of the handle 400 or other engagement feature. The head portion 304 is coupled to the neck portion 302 and has a generally elongate shape suitable for insertion into a user's oral cavity. The head portion 304 is configured to engage the user's teeth during normal brushing activities, with a focus on minimizing head thickness and optimizing reach to enable reaching the rearmost portions of the user's mouth during brushing. The head 300 extends along a longitudinal axis A-A.

As can be seen, the head portion 304 has a plurality of bristle tufts 352, the plurality of bristle tufts 352 extending from first and second tuft blocks 353. The head portion 304 may comprise one, two, or more than two tuft blocks 353 as desired. The bristle tufts 352 are formed of filament bristles, and may be formed of any known bristle filament material. Such materials may include Polybutylene Terephthalate (“PBT”), nylon, polypropylene, or other natural or synthetic materials. In other configurations, the bristle tufts 352 may be formed as a plurality of injection molded bristles, or any other type of molded or filament teeth cleaning elements. In other words, some bristle tufts 352 may be substituted for elastomeric or other molded teeth cleaning elements or for one or more molded bristles.

The head portion 304 further includes a guard structure 390 that surrounds and encapsulates the tuft blocks 353, leaving a front surface 355 of the tuft blocks 355 exposed. The guard structure 390 is flush with the front surface 355 at an interface, ensuring a smooth transition between the tuft blocks 353 and the guard structure 390. The guard structure 390 is also flush with the neck portion 302 at an interface, ensuring a smooth mouthfeel without risk of user discomfort while brushing. The guard structure 390 extends to a lower portion 303, also facilitating an improved seal with the stem of the handle 400.

The head portion 304 also includes a base structure 370. The base structure 370 may be formed of a metallic material as above. The base structure 370 may preferably be formed of a sheet metal material and has a front surface 373 and an opposite rear surface 374. The base structure 370 also comprises a plurality of apertures 371. The apertures 371 extend through the base structure 370 from the front surface 373 to the rear surface 374. The apertures 371 are analogous to the apertures 171 described above, allowing the tuft blocks 353 or tuft holes of the tuft blocks 353 to extend through the apertures 371.

The base structure 370 further extends from a proximal end 375 to a distal end 376. The apertures 371 are located at the distal end 376 while the neck portion 302 is coupled to the proximal end 375. Thus, the tuft blocks 353 are located at and formed on the distal end 376 while the neck portion 102 is located at the proximal end 375. A connector 314 is formed as a part of the base structure 370, the connector 314 connecting the neck portion 302 to the head portion 304. The connector 314 and the base structure 370 are formed as a monolithic, integrally formed, component. As illustrated, the connector 314 is formed at the proximal end 375 of the base structure 370. In other implementations, the connector 314 may be a separately formed component which is welded, bolted, or otherwise fastened to the base structure 370 using techniques known in the art.

The tuft blocks 353 extend from the front surface 355 to an opposite rear surface 356. A perimeter 357 extends from the front surface 355 to the rear surface 356. The base structure 370 intersects the perimeter 357 of the tuft blocks 353. Thus, portions of the front and rear surfaces 373, 374 of the base structure 370 are covered by the tuft blocks 353. This is because the base structure 370 intersects the perimeter 357 of the tuft blocks 353. The tuft blocks have a front portion 358, a rear portion 359, and a coupling portion 360. The front portion 358 is in contact with the front surface 373 of the base structure 370. The rear portion 359 in contact with and extending from the rear surface 374 of the base structure to the rear surface 356 of the tuft blocks 353. The coupling portion 360 extends through the apertures 371 of the base structure 370 from the front surface 373 to the rear surface 374. Thus, the coupling portion 360 connects the front portion 358 and the rear portion 359.

A plurality of tuft holes 354 are formed into the front surfaces 355 of the tuft blocks 353, the tuft holes 354 extending through the apertures 371. The bristle tufts 352 each have a base portion 362 and a free portion 363. The base portions 362 are located within the tuft holes 354 while the free portions 363 extend from the front surface 355 of the tuft blocks 353. The base portions 362 may be secured with an anchor, anchor free tufting, or other techniques known in the art as discussed above.

Optionally, the tuft holes 354 may extend through the apertures 371 of the base structure 370 as noted above. Optionally, the tuft holes 354 may also extend through the front portion 358 and the coupling portion 360. Thus, the tuft holes 354 may terminate within the rear portion 359. Alternately, the tuft holes 354 may terminate at the front surface 373 of the base structure 370, within the coupling portion 360, or within the rear portion 359. In yet other possible configurations, the tuft holes 354 may extend through the entirety of the tuft blocks 353 and through the apertures 371.

The tuft blocks 353 further incorporate a plurality of protuberances 361 extending from the rear surface 356. The plurality of protuberances 361 may extend from the rear portion 359. The plurality of protuberances 361 extend away from the front surface 355 of the tuft blocks 353. In other possible configurations, the base structure 370 may located on the front surface 355 or rear surface 356 of the tuft blocks 353. In these configurations, the protuberances 361 may extend from the rear surface 355 of the tuft blocks 353. Optionally, the rear surface 355 may be formed on the coupling portion 360 or on the rear portion 359. Where the rear surface 355 is formed on the coupling portion 360, the rear portion 359 may be omitted. In this implementation, the rear surface 355 may be coplanar with the rear surface 374 of the base structure 370.

Optionally, the base structure 370 may be formed of a metallic material, a metal, or any other material having relatively high vibration transmissibility. Preferably, the base structure 370 is formed of a steel such as a low carbon steel, a medium carbon steel, a spring steel, a stainless steel, or any other alloy principally comprising iron. Preferably, the base structure 370 is formed of a sheet metal such as sheet steel. The tuft blocks 353 may be optionally formed of a polymer material or other material suitable for receiving bristles or forming bristles thereon. The material of the tuft blocks 353 is preferably selected to optimize tuft retention or other features relating to mounting, coupling, or otherwise attaching tooth cleaning elements such as bristles. The material of the tuft blocks 352 may be acrylonitrile butadiene styrene (ABS), polyethylene terephthalate (PET), polybutylene terephthalate (PBT), nylon, polypropylene (PP), polyethylene naphthalate (PEN), polyethylene (PE), silicone, ethylene propylene diene monomer (EPDM), polycarbonate (PC), thermoplastic elastomers (TPE), and other plastics and elastomeric materials. Preferably, the tuft blocks 353 are formed of ABS, polypropylene, or another hard plastic rather than an elastomeric material.

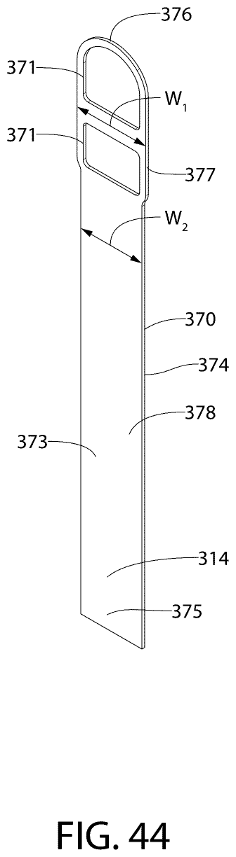

Turning to FIG. 44, the base structure 370 is illustrated in greater detail. The base structure 370 extends from the proximal end 375 to the distal end 376 as noted above. The base structure 370 has a front surface 373 and rear surface 374, with a plurality of apertures 371 extending through the base structure 370 from the front surface 373 to the rear surface 374. The connector 314 is located at the proximal end 375. A first portion 377 includes the distal end 376 and the apertures 371, the first portion 377 being covered by the tuft blocks 353 in subsequent processing steps. A second portion 378 extends from the first portion 377 to the proximal end 375. The first portion 377 has a first width W₁ while the second portion 378 has a second width W₂. The first width W₁ is greater than the second width W₂.

Preferably the base structure 370 is provided in a first processing step, the base structure 370 being optionally formed of stamped or laser cut sheet metal. The base structure 370 provides mechanical strength and flexibility to the resulting head 300 while adding minimal thickness to the head 300.

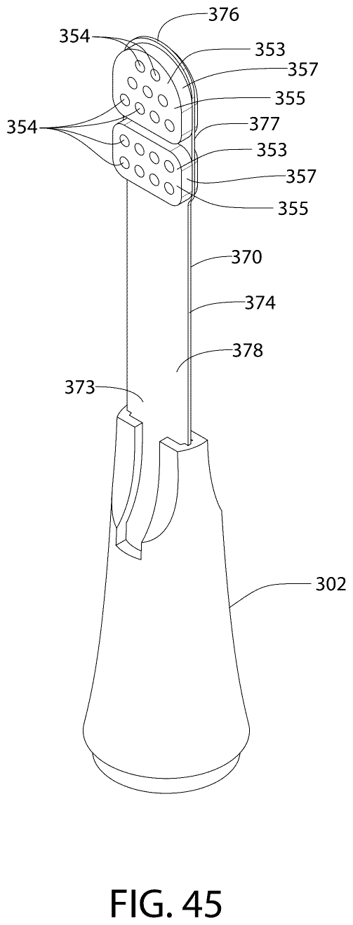

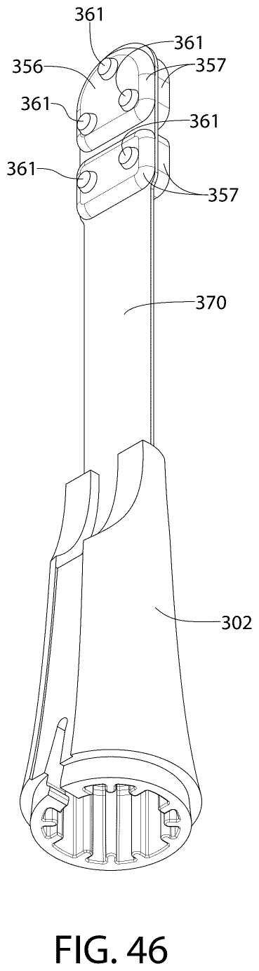

FIGS. 45 and 46 illustrates the base structure 370, two tuft blocks 353, and the neck portion 302. Optionally, the tuft blocks 353 and the neck portion 302 may be molded onto the base structure 370 in a second processing step. The tuft blocks 353 and the neck portion 302 may be molded simultaneously or in subsequent process steps. The tuft blocks 353 remain un-tufted, with the tuft holes 354 empty of bristle filaments in this state. As can be seen, the base structure 370 is securely coupled to the neck portion 302 via the connector 314. The tuft blocks 353 extend through the apertures 371, with the base structure 370 intersecting the perimeters 357 of the tuft blocks 353. In other configurations, the neck portion 302 may be coupled or formed in a subsequent process step.

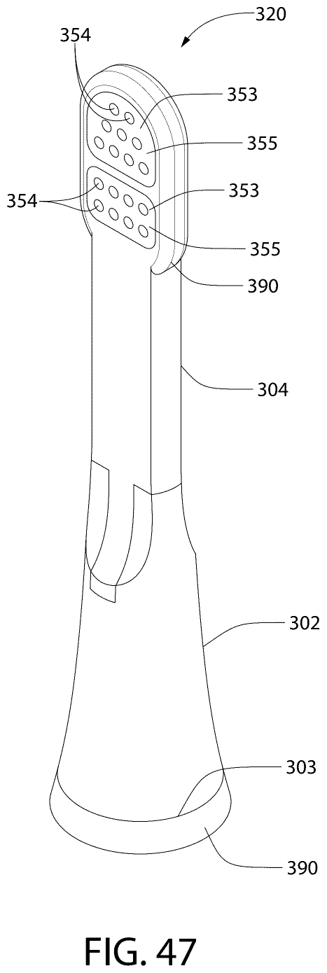

FIG. 47 illustrates a head subassembly 320, the head subassembly 320 comprising the base structure 370, the tuft blocks 353, and the guard structure 390. The head subassembly 320 is formed when the guard structure 390 is formed onto the base structure 370, the tuft blocks 353, and the neck portion 302. The head subassembly 320 is substantially complete with the exception of installation of the bristle tufts 352. In some other implementations, some or all tooth cleaning elements may be formed prior to, concurrently with, or immediately subsequently to the formation of the guard structure 190. For instance, it is contemplated that some tooth cleaning elements may be integrally formed, monolithic, features of the guard structure 190.

The guard structure 390 and the tuft blocks 353 preferably cover an entirety of the base structure 370. The guard structure 390 has an outer surface 391 comprising a front surface 393, a rear surface 394, and a perimeter surface 395. The front surface 393 is substantially coplanar with the front surface 355 of the tuft blocks 353 while the rear surface 394 covers the rear surface 356 of the tuft blocks 353. Thus, the front surface 393 of the guard structure 390 and the front surface 355 of the tuft blocks 353 are flush at an interface between the guard structure 390 and the tuft blocks 353. The guard structure 390, in combination with the tuft blocks 353 and the neck portion 302, encapsulate the guard structure 370. A portion of the proximal end 375 of the guard structure 370 may remain exposed within the neck portion 302, or may be covered by the neck portion 302.

The perimeter surface 395 is spaced from an edge of the base structure 370. Preferably, the protuberances 361 terminate in a surface that is substantially coplanar and flush with the rear surface 394 of the guard structure 390. The protuberances 361 may be any number, and in some configurations some of the protuberances 361 may also serve as cleaning or massaging elements that extend beyond the rear surface 394 of the guard structure 390.

The guard structure 390 may be constructed from sheet material or it may be a molded component which is either molded separately or over molded onto the base structure 370 and the tuft blocks 353. In certain embodiments, the guard structure 390 may be formed, at least in part, of a biocompatible material, such as a food grade polymer. Suitable biocompatible materials include, without limitation, acrylonitrile butadiene styrene (ABS), polyethylene terephthalate (PET), polybutylene terephthalate (PBT), nylon, polypropylene (PP), polyethylene naphthalate (PEN), polyethylene (PE), silicone, ethylene propylene diene monomer (EPDM), polycarbonate (PC), thermoplastic elastomers (TPE), and other plastics and elastomeric materials. Of course, the invention is not to be so limited in all embodiments and other materials are possible for construction of the guard structure 390, and various components thereof. In certain embodiments, the guard structure 390, or at least portions thereof, may be formed of an elastomeric material. A hybrid construction including components having different materials is contemplated.

Optionally, the guard structure 390 may be overmolded onto the base structure 370 and tuft blocks 353. Alternately, the guard structure 390 may be formed separately and bonded, welded, or otherwise joined to the base structure 370 and tuft blocks 353. It is contemplated that the guard structure 390 may be a single, monolithic, component formed of an elastomeric material or that it may be formed as two or more components which are subsequently joined to encapsulate the base structure 370 and surround the tuft blocks 353.

In a final processing step, the head subassembly 320 may be tufted, such that the tuft holes 354 each have bristle tufts 352 located therein. This results in a complete head 300 suitable for use by the end user. As noted above, the bristle tufts 352 may be installed in a variety of processes, and they may be installed in a different order as required by the specific tufting process or other process considerations.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

### Exemplary Claim Set:

Exemplary claim 1. An oral care implement comprising: a handle; and a head coupled to the handle, the head comprising: a neck portion; and a head portion coupled to the neck portion, the head portion comprising: a base structure; a plurality of tuft blocks in contact with the base structure, each of the plurality of tuft blocks comprising a front surface, a rear surface, a perimeter extending from the front surface to the rear surface, and a plurality of bristle tufts extending from the front surface of each of the plurality of tuft blocks; and a guard structure, the guard structure encapsulating the base structure and surrounding the perimeter of a first one of the plurality of tuft blocks.

Exemplary claim 2. The oral care implement of claim 1 wherein each of the plurality of tuft blocks comprises a plurality of tuft holes formed in the front surface, the plurality of tuft holes receiving the plurality of bristle tufts.

Exemplary claim 3. The oral care implement of exemplary claim 2 wherein the plurality of tuft holes extend through the base structure.

Exemplary claim 4. The oral care implement of any one of exemplary claims 1 to 3 wherein the base structure comprises an aperture, a coupling portion of the first one of the plurality of tuft blocks extending through the aperture.

Exemplary claim 5. The oral care implement of any one of exemplary claims 1 to 4 wherein the plurality of tuft blocks comprise a front portion, a rear portion, and a coupling portion, the front portion in contact with a front surface of the base structure and the rear portion in contact with a rear surface of the base structure, the coupling portion joining the front portion to the rear portion.

Exemplary claim 6. The oral care implement of any one of exemplary claims 1 to 5 wherein the base structure has a front surface and an opposite rear surface, a first portion of the front surface of the base structure in direct surface contact with the first one of the plurality of tuft blocks.

Exemplary claim 7. The oral care implement of any one of exemplary claims 1 to 6 wherein the base structure intersects the perimeter of the first one of the plurality of tuft blocks.

Exemplary claim 8. The oral care implement of any one of exemplary claims 1 to 7 wherein the base structure intersects the first one of the plurality of tuft blocks between the front surface and the rear surface of the first one of the plurality of tuft blocks.

Exemplary claim 9. The oral care implement of any one of exemplary claims 1 to 8 wherein the first one of the plurality of tuft blocks comprises a plurality of protuberances extending from the rear surface of the first one of the plurality of tuft blocks.

Exemplary claim 10. The oral care implement of exemplary claim 9 wherein the guard structure covers the rear surface of the first one of the plurality of tuft blocks, the plurality of protuberances remaining exposed.

Exemplary claim 11. The oral care implement of any one of exemplary claims 1 to 10 wherein the front surface of the first one of the plurality of tuft blocks and the guard structure are flush at an interface.

Exemplary claim 12. The oral care implement of any one of exemplary claims 1 to 11 wherein the base structure is formed of sheet metal.

Exemplary claim 13. The oral care implement of any one of exemplary claims 1 to 12 wherein the head portion extends along an arcuate path.

Exemplary claim 14. The oral care implement of any one of exemplary claims 1 to 13 wherein the head portion comprises a concave wall and a plurality of fingers extending from the wall.

Exemplary claim 15. The oral care implement of exemplary claim 14 wherein the plurality of fingers each comprise a horizontal portion extending from the wall along a horizontal plane.

Exemplary claim 16. The oral care implement of exemplary claim 15 wherein each of the plurality of fingers comprise a bend and a tip portion, the tip portion of the fingers diverging from the horizontal plane at the bend.

Exemplary claim 17. The oral care implement of any one of exemplary claims 14 to 16 wherein a first one of the plurality of fingers comprises second and third ones of the plurality of tuft blocks.

Exemplary claim 18. The oral care implement of any one of exemplary claims 1 to 17 wherein the base structure has a front surface and an opposite rear surface, the guard structure encapsulating the rear surface of the base structure.

Exemplary claim 19. The oral care implement of any one of exemplary claims 1 to 18 wherein the base structure has a front surface and an opposite rear surface, the base structure and the plurality of tuft blocks collectively covering an entirety of the rear surface of the base structure.

Exemplary claim 20. The oral care implement of any one of exemplary claims 1 to 19 wherein the plurality of tuft blocks are formed of a hard plastic.

Exemplary claim 21. The oral care implement of any one of exemplary claims 1 to 20 wherein the guard structure is formed of an elastomeric material.

Exemplary claim 22. A head of an oral care implement comprising: a neck portion; and a head portion coupled to the neck portion, the head portion comprising: a base structure having a front surface and an opposite rear surface; a plurality of tuft blocks, each of the plurality of tuft blocks comprising a front surface, a rear surface, and a plurality of bristle tufts extending from the front surface of each of the plurality of tuft blocks; and a guard structure, the guard structure encapsulating the base structure; wherein a first portion of the front surface of the base structure is in direct surface contact with a first one of the plurality of tuft blocks.

Exemplary claim 23. The head of exemplary claim 22 wherein each of the plurality of tuft blocks comprises a plurality of tuft holes formed in the front surface, the plurality of tuft holes receiving the plurality of bristle tufts.

Exemplary claim 24. The head of exemplary claim 23 wherein the plurality of tuft holes extend through the base structure.

Exemplary claim 25. The head of any one of exemplary claims 22 to 24 wherein the base structure comprises an aperture, a coupling portion of the first one of the plurality of tuft blocks extending through the aperture.

Exemplary claim 26. The head of any one of exemplary claims 22 to 25 wherein the plurality of tuft blocks comprise a front portion, a rear portion, and a coupling portion, the front portion in contact with the front surface of the base structure and the rear portion in contact with the rear surface of the base structure, the coupling portion joining the front portion to the rear portion.

Exemplary claim 27. The head of any one of exemplary claims 22 to 26 wherein a first portion of the front surface of the base structure is in direct surface contact with the first one of the plurality of tuft blocks.

Exemplary claim 28. The head of any one of exemplary claims 22 to 27 wherein each of the plurality of tuft blocks comprises a perimeter extending from the front surface to the rear surface.

Exemplary claim 29. The head of exemplary claim 28 wherein the base structure intersects the perimeter of the first one of the plurality of tuft blocks.

Exemplary claim 30. The head of any one of exemplary claims 22 to 29 wherein the base structure intersects the first one of the plurality of tuft blocks between the front surface and the rear surface of the first one of the plurality of tuft blocks.

Exemplary claim 31. The head of any one of exemplary claims 22 to 30 wherein the first one of the plurality of tuft blocks comprises a plurality of protuberances extending from the rear surface of the first one of the plurality of tuft blocks.

Exemplary claim 32. The head of exemplary claim 31 wherein the guard structure covers the rear surface of the first one of the plurality of tuft blocks, the plurality of protuberances remaining exposed.

Exemplary claim 33. The head of any one of exemplary claims 22 to 32 wherein the front surface of the first one of the plurality of tuft blocks and the guard structure are flush at an interface.

Exemplary claim 34. The head of any one of exemplary claims 22 to 33 wherein the base structure is formed of sheet metal.

Exemplary claim 35. The head of any one of exemplary claims 22 to 34 wherein the head portion extends along an arcuate path.

Exemplary claim 36. The head of any one of exemplary claims 22 to 35 wherein the head portion comprises a concave wall and a plurality of fingers extending from the wall.

Exemplary claim 37. The head of exemplary claim 36 wherein the plurality of fingers each comprise a horizontal portion extending from the wall along a horizontal plane.

Exemplary claim 38. The head of exemplary claim 37 wherein each of the plurality of fingers comprise a bend and a tip portion, the tip portion of the fingers diverging from the horizontal plane at the bend.

Exemplary claim 39. The head of any one of exemplary claims 36 to 38 wherein a first one of the plurality of fingers comprises second and third ones of the plurality of tuft blocks.

Exemplary claim 40. The head of any one of exemplary claims 22 to 39 wherein the guard structure encapsulates the rear surface of the base structure.

Exemplary claim 41. The head of any one of exemplary claims 22 to 40 wherein the base structure and the plurality of tuft blocks collectively cover an entirety of the rear surface of the base structure.

Exemplary claim 42. The head of any one of exemplary claims 22 to 41 wherein the plurality of tuft blocks are formed of a hard plastic.

Exemplary claim 43. The head of any one of exemplary claims 22 to 42 wherein the guard structure is formed of an elastomeric material.

Exemplary claim 44. A method of manufacturing a head of an oral care implement comprising: a) providing a base structure, the base structure comprising a front surface and an opposite rear surface; b) forming a first tuft block comprising a plurality of tuft holes extending from a front surface, the first tuft block in contact with a first portion of the front surface of the base structure or a first portion of the rear surface of the base structure; and c) encapsulating the front and rear surfaces of the base structure while leaving the front surface of the first tuft block exposed to form a head subassembly.

Exemplary claim 45. The method of exemplary claim 44 further comprising step d), wherein, in step d), a plurality of bristle tuft bundles are inserted into the plurality of tuft holes of the first tuft block to form a plurality of bristle tufts.

Exemplary claim 46. The method of exemplary claim 45 wherein the plurality of bristle tuft bundles comprise a base portion and a free portion, wherein in step d), the base portion of each of the plurality of bristle tuft bundles is inserted within a respective one of the plurality of tuft holes such that each of the base portions of the plurality of bristle tuft bundles extends through the base structure.

Exemplary claim 47. The method of any one of exemplary claims 44 to 46 further comprising step e), wherein, in step e), the head subassembly is bent to form a head portion.

Exemplary claim 48. The method of exemplary claim 47 wherein the head portion comprises a plurality of fingers, a first one of the plurality of fingers comprising second and third tuft blocks, a first bend separating the first tuft block from the second tuft block and a second bend separating the second tuft block from the third tuft block.

Exemplary claim 49. The method of any one of exemplary claims 44 to 48 wherein, in step b), the first tuft block comprises a front portion, a rear portion, and a coupling portion, the front portion in contact with the front surface of the base structure and the rear portion in contact with the rear surface of the base structure, the coupling portion joining the front portion to the rear portion.

Exemplary claim 50. The method of any one of exemplary claims 44 to 49 wherein, in step b), the first tuft block is in direct surface contact with both the front and rear surfaces of the base structure.

Exemplary claim 51. The method of any one of exemplary claims 44 to 50 wherein, in step a), the base structure comprises an aperture, a coupling portion of the first tuft block extending through the aperture.

Exemplary claim 52. An oral care implement comprising: a handle; and a head coupled to the handle, the head comprising: a neck portion; and a head portion coupled to the neck portion, the head portion comprising: a base structure comprising a front surface, a rear surface, and an aperture; a plurality of tuft blocks in contact with the base structure, each of the plurality of tuft blocks comprising a front surface, a rear surface, a perimeter extending from the front surface to the rear surface, and a plurality of tuft holes formed in the front surface of each of the plurality of tuft blocks, a plurality of bristle tufts extending from the plurality of tuft hole holes; and a guard structure, the guard structure in direct surface contact with the front or rear surface of the base structure; wherein a first one of the plurality of tuft holes of a first one of the plurality of tuft blocks extends through the aperture of the base structure.

Exemplary claim 53. The oral care implement of exemplary claim 52 wherein a first one of the plurality of tuft blocks has a height, the plurality of tuft holes of the first one of the plurality of tuft blocks have a depth, the height equal to the depth.

Exemplary claim 54. The oral care implement of exemplary claim 52 wherein the front surfaces of the plurality of tuft blocks are in direct surface contact with the rear surface of the base structure.

Exemplary claim 55. The oral care implement of exemplary claim 52 wherein the base structure intersects the perimeters of the plurality of bristle tufts.

Exemplary claim 56. The oral care implement of exemplary claim 52 wherein the rear surfaces of the plurality of tuft blocks remain exposed through the guard structure.

Exemplary claim 57. The oral care implement of any one of exemplary claims 52 to 56 wherein the plurality of tuft holes of the first one of the plurality of tuft blocks extends through the aperture.

Exemplary claim 58. The oral care implement of any one of exemplary claims 52 to 56 wherein the first one, a second one, and a third one of the plurality of tuft holes of the first one of the plurality of tuft blocks extends through the aperture.

Exemplary claim 59. The oral care implement of any one of exemplary claims 52 to 56 wherein the base structure comprises a plurality of apertures, each of the plurality of apertures comprising a single tuft hole extending therethrough.

Exemplary claim 60. The oral care implement of any one of exemplary claims 52 to 59 wherein the guard structure encapsulates the base structure and surrounds the perimeter of the first one of the plurality of tuft blocks.

Exemplary claim 61. The oral care implement of any one of exemplary claims 52 to 60 wherein the plurality of tuft blocks comprise a front portion, a rear portion, and a coupling portion, the front portion in contact with the front surface of the base structure and the rear portion in contact with the rear surface of the base structure, the coupling portion joining the front portion to the rear portion.

Exemplary claim 62. The oral care implement of any one of exemplary claims 52 to 61 wherein the base structure intersects the first one of the plurality of tuft blocks between the front surface and the rear surface of the first one of the plurality of tuft blocks.

Exemplary claim 63. The oral care implement of any one of exemplary claims 52 to 55 and 57 to 62 wherein the first one of the plurality of tuft blocks comprises a plurality of protuberances extending from the rear surface of the first one of the plurality of tuft blocks.

Exemplary claim 64. The oral care implement of exemplary claim 63 wherein the guard structure covers the rear surface of the first one of the plurality of tuft blocks, the plurality of protuberances remaining exposed.

Exemplary claim 65. A head of an oral care implement comprising: a neck portion; and a head portion coupled to the neck portion, the head portion comprising: a base structure comprising a front surface, a rear surface, and an aperture; a plurality of tuft blocks in contact with the base structure, each of the plurality of tuft blocks comprising a front surface, a rear surface, a perimeter extending from the front surface to the rear surface, and a plurality of tuft holes formed in the front surface of each of the plurality of tuft blocks, a plurality of bristle tufts extending from the plurality of tuft holes; and a guard structure, the guard structure in direct surface contact with the front or rear surface of the base structure; wherein a first one of the plurality of tuft holes of a first one of the plurality of tuft blocks has a depth which is equal to a height of the first one of the plurality of tuft blocks.

Exemplary claim 66. The head of exemplary claim 65 wherein the first one of the plurality of tuft holes of the first one of the plurality of tuft blocks extends through the aperture of the base structure.

Exemplary claim 67. The head of exemplary claim 65 or exemplary claim 66 wherein the base structure intersects the perimeters of the plurality of bristle tufts.

Exemplary claim 68. The head of any one of exemplary claims 65 to 67 wherein the plurality of tuft holes of the first one of the plurality of tuft blocks extends through the aperture.

Exemplary claim 69. The head of any one of exemplary claims 65 to 68 wherein the first one, a second one, and a third one of the plurality of tuft holes of the first one of the plurality of tuft blocks extends through the aperture.

Exemplary claim 70. The head of any one of exemplary claims 65 to 69 wherein the base structure comprises a plurality of apertures, each of the plurality of apertures comprising a single tuft hole extending therethrough.

Exemplary claim 71. The head of any one of exemplary claims 65 to 70 wherein the guard structure encapsulates the base structure and surrounds the perimeter and the rear surface of the first one of the plurality of tuft blocks.

Exemplary claim 72. The head of any one of exemplary claims 65 to 71 wherein the plurality of tuft blocks comprise a front portion, a rear portion, and a coupling portion, the front portion in contact with the front surface of the base structure and the rear portion in contact with the rear surface of the base structure, the coupling portion joining the front portion to the rear portion.

Exemplary claim 73. The head of any one of exemplary claims 65 to 72 wherein the base structure intersects the first one of the plurality of tuft blocks between the front surface and the rear surface of the first one of the plurality of tuft blocks.

Exemplary claim 74. The head of any one of exemplary claims 65 to 73 wherein the first one of the plurality of tuft blocks comprises a plurality of protuberances extending from the rear surface of the first one of the plurality of tuft blocks.

Exemplary claim 75. The head of exemplary claim 74 wherein the guard structure covers the rear surface of the first one of the plurality of tuft blocks, the plurality of protuberances remaining exposed.

Exemplary claim 76. A method of manufacturing a head of an oral care implement comprising: a) providing a base structure, the base structure comprising a front surface and an opposite rear surface; b) forming a first tuft block comprising a plurality of tuft holes, the first tuft block in contact with the base structure; and c) covering the base structure while leaving the plurality of tuft holes of the first tuft block exposed to form a head subassembly.

Exemplary claim 77. The method of exemplary claim 76 further comprising step d), wherein, in step d), a plurality of bristle tuft bundles are inserted into the plurality of tuft holes of the first tuft block to form a plurality of bristle tufts.

Exemplary claim 78. The method of exemplary claim 77 wherein the plurality of bristle tuft bundles comprise a base portion and a free portion, wherein in step d), the base portion of each of the plurality of bristle tuft bundles is inserted within a respective one of the plurality of tuft holes such that each of the base portions of the plurality of bristle tuft bundles extends through the base structure.

Exemplary claim 79. The method of any one of exemplary claims 76 to 78 further comprising step e), wherein, in step e), the head subassembly is bent to form a head portion.

Exemplary claim 80. The method of exemplary claim 79 wherein the head portion comprises a plurality of fingers, a first one of the plurality of fingers comprising second and third tuft blocks, a first bend separating the first tuft block from the second tuft block and a second bend separating the second tuft block from the third tuft block.

Exemplary claim 81. The method of any one of exemplary claims 76 to 80 wherein, in step b), the first tuft block comprises a front portion, a rear portion, and a coupling portion, the front portion in contact with the front surface of the base structure and the rear portion in contact with the rear surface of the base structure, the coupling portion joining the front portion to the rear portion.

Exemplary claim 82. The method of any one of exemplary claims 76 to 81 wherein, in step b), the first tuft block is in direct surface contact with both the front and rear surfaces of the base structure.

Exemplary claim 83. The method of any one of exemplary claims 76 to 82 wherein, in step a), the base structure comprises an aperture, a coupling portion of the first tuft block extending through the aperture.

Exemplary claim 84. The method of any one of exemplary claims 76 to 81 wherein, in step b), an entirety of the front surface of the base structure remains exposed.

Exemplary claim 85. An oral care implement comprising: a handle; and a head coupled to the handle, the head comprising: a neck portion; and a head portion coupled to the neck portion, the head portion comprising: a base structure comprising a plurality of pre-weakened areas; a plurality of tuft blocks in contact with the base structure, each of the plurality of tuft blocks comprising a plurality of bristle tufts; and a guard structure, the guard structure encapsulating the base structure and covering the plurality of pre-weakened areas.

Exemplary claim 86. The oral care implement of exemplary claim 85 wherein the plurality of pre-weakened areas may comprise an aperture, notches, or a groove in the base structure.

Exemplary claim 87. The oral care implement of exemplary claim 85 or exemplary claim 86 wherein the head portion has a plurality of bends located at the plurality of pre-weakened areas.

Exemplary claim 88. The oral care implement of exemplary claim 87 wherein each of the plurality of bends have a spring rate measured as a deflection in response to an applied force, a first bend having a greater spring rate than the spring rate of a second bend.

Exemplary claim 89. The oral care implement of any one of exemplary claims 85 to 88 wherein the first tuft block is located between a first one of the plurality of pre-weakened areas and a second one of the plurality of pre-weakened areas.

Exemplary claim 90. The oral care implement of any one of exemplary claims 85 to 89 wherein the base structure has a perimeter, the plurality of pre-weakened areas comprising apertures formed within the perimeter of the base structure.

Exemplary claim 91. The oral care implement of any one of exemplary claims 85 to 89 wherein the base structure has a perimeter, the plurality of pre-weakened areas comprising notches forming a portion of the perimeter of the base structure.

Exemplary claim 92. The oral care implement of any one of exemplary claims 85 to 91 wherein the head portion has a spring rate at the plurality of pre-weakened areas which is less than a spring rate of a surrounding portion of the head portion.

Exemplary claim 93. The oral care implement of any one of exemplary claims 85 to 92 wherein the plurality of tuft blocks comprise first and second tuft blocks, the first tuft block located between first and second ones of the plurality of pre-weakened areas and the second tuft block is located between the second one of the plurality of pre-weakened areas and a third one of the plurality of pre-weakened areas.

Exemplary claim 94. The oral care implement of exemplary claim 93 wherein the head portion has a greater spring rate at the first and second ones of the plurality of pre-weakened areas than the third one of the plurality of pre-weakened areas.

Exemplary claim 95. A head of an oral care implement comprising: a neck portion; and a head portion coupled to the neck portion, the head portion comprising: a base structure comprising a plurality of pre-weakened areas; a plurality of tuft blocks in contact with the base structure, each of the plurality of tuft blocks comprising a plurality of bristle tufts, a first one of the plurality of tuft blocks located between a first one of the plurality of pre-weakened areas and a second one of the plurality of pre-weakened areas; and a guard structure, the guard structure encapsulating the base structure and covering the plurality of pre-weakened areas.

Exemplary claim 96. The head of exemplary claim 95 wherein the plurality of pre-weakened areas may comprise an aperture, notches, or a groove in the base structure.

Exemplary claim 97. The head of exemplary claim 95 or exemplary claim 96 wherein the head portion has a plurality of bends located at the plurality of pre-weakened areas.

Exemplary claim 98. The head of exemplary claim 97 wherein each of the plurality of bends have a spring rate measured as a deflection in response to an applied force, a first bend located at the first one of the plurality of pre-weakened areas having a greater spring rate than the spring rate of a second bend located at the second one of the plurality of pre-weakened areas.

Exemplary claim 99. The head of any one of exemplary claims 95 to 98 wherein the base structure has a perimeter, the plurality of pre-weakened areas comprising apertures formed within the perimeter of the base structure.

Exemplary claim 100. The head of any one of exemplary claims 95 to 98 wherein the base structure has a perimeter, the plurality of pre-weakened areas comprising notches forming a portion of the perimeter of the base structure.

Exemplary claim 101. The head of any one of exemplary claims 95 to 100 wherein the head portion has a spring rate at the plurality of pre-weakened areas which is less than a spring rate of a surrounding portion of the head portion.

Exemplary claim 102. The head of any one of exemplary claims 95 to 101 wherein the plurality of tuft blocks comprise a second tuft block, the second tuft block located between the second one of the plurality of pre-weakened areas and a third one of the plurality of pre-weakened areas.

Exemplary claim 103. The head of exemplary claim 102 wherein the head portion has a greater spring rate at the first and second ones of the plurality of pre-weakened areas than the third one of the plurality of pre-weakened areas.

Exemplary claim 104. A method of manufacturing a head of an oral care implement comprising: a) providing a base structure; b) forming first and second tuft blocks each comprising a plurality of tuft holes, the first and second tuft blocks in contact with the base structure, the first tuft block spaced and isolated from the second tuft block; c) covering at least a portion of the base structure with a guard structure; and d) bending the base structure to form a first bend between the first and second tuft blocks.

Exemplary claim 105. The method of exemplary claim 104 wherein the base structure comprises a first pre-weakened area.

Exemplary claim 106. The method of exemplary claim 105 wherein the first pre-weakened area may comprise an aperture, notches, or a groove in the base structure.

Exemplary claim 107. The method of exemplary claim 105 or 106 wherein, in step d), the first bend is located at the first pre-weakened area.

Exemplary claim 108. The method of any one of exemplary claims 105 to 107 wherein the base structure has a perimeter, the first pre-weakened area comprising notches forming a portion of the perimeter of the base structure.

Exemplary claim 109. The method of any one of exemplary claims 105 to 107 wherein the base structure has a perimeter, the first pre-weakened area comprising apertures formed within the perimeter of the base structure.

Exemplary claim 110. The method of any one of exemplary claims 104 to 109 wherein, in step b), a third tuft block is formed, the third tuft block in contact with the base structure and comprising a plurality of tuft holes, the third tuft block spaced and isolated from the first and second tuft blocks; and wherein, in step d), a second bend is formed between the second and third tuft blocks.

Exemplary claim 111. The method of exemplary claim 110 wherein the each of the first and second bends have a spring rate measured as a deflection in response to an applied force, the first bend having a greater spring rate than the spring rate of the second bend.

Exemplary claim 112. An oral care implement comprising: a handle; and a head coupled to the handle, the head comprising: a neck portion comprising a connector; and a head portion coupled to the neck portion, the head portion comprising: a wall; a plurality of fingers extending from the wall; a connector coupled to the wall and the connector of the neck portion; and first and second bends located along the wall; wherein the connector of the neck portion covers at least a portion of the first and second bends.

Exemplary claim 113. The oral care implement of exemplary claim 112 wherein the connector of the neck portion is coupled to the connector of the head portion via a snap fastener.

Exemplary claim 114. The oral care implement of exemplary claim 112 or 113 wherein the wall comprises first and second tuft blocks, each of the first and second tuft blocks comprising a front surface and a plurality of bristle tufts extending from a front surface.

Exemplary claim 115. The oral care implement of exemplary claim 114 wherein the first and second bends each have a spring rate which is less than a spring rate of the head portion at the first and second tuft blocks.

Exemplary claim 116. The oral care implement of any one of exemplary claims 112 to 115 wherein the wall of the head portion has a concave curvature formed by the first and second bends.

Exemplary claim 117. The oral care implement of any one of exemplary claims 112 to 116 wherein the head portion comprises a base structure and a plurality of tuft blocks coupled to the base structure, the first and second bends located on opposite sides of a first one of the plurality of tuft blocks.

Exemplary claim 118. The oral care implement of any one of exemplary claims 112 to 117 wherein the head portion comprises a base structure, the connector of the head portion coupled to the base structure.

Exemplary claim 119. The oral care implement of exemplary claim 118 wherein the connector of the head portion is an integrally formed, monolithic, portion of the base structure.

Exemplary claim 120. The oral care implement of any one of exemplary claims 112 to 119 further comprising a third bend located along the wall, wherein each of the first, second, and third bends has a spring rate, the spring rate of the third bend being less than the spring rates of the first and second bends.

Exemplary claim 121. The oral care implement of any one of exemplary claims 112 to 120 wherein a first one of the plurality of fingers comprises a third tuft block and a fourth tuft block, a third bend located between the wall and the third tuft block and a fourth bend located between the third tuft block and the fourth tuft block.

Exemplary claim 122. A head of an oral care implement comprising: a neck portion comprising a connector; and a head portion coupled to the neck portion, the head portion comprising: a wall; a plurality of fingers extending from the wall; a connector coupled to the wall and the connector of the neck portion; and first and second bends located along the wall; wherein each of the first and second bends having a spring rate, the connector of the neck portion increasing the spring rate of the first and second bends.

Exemplary claim 123. The head of exemplary claim 122 wherein the connector of the neck portion covers at least a portion of the first and second bends.

Exemplary claim 124. The head of exemplary claim 122 or 123 wherein the connector of the neck portion is coupled to the connector of the head portion via a snap fastener.

Exemplary claim 125. The head of any one of exemplary claims 122 to 124 wherein the wall comprises first and second tuft blocks, each of the first and second tuft blocks comprising a front surface and a plurality of bristle tufts extending from a front surface.

Exemplary claim 126. The head of exemplary claim 125 wherein the first and second bends each have a spring rate which is less than a spring rate of the head portion at the first and second tuft blocks.

Exemplary claim 127. The head of any one of exemplary claims 122 to 126 wherein the wall of the head portion has a concave curvature formed by the first and second bends.

Exemplary claim 128. The head of any one of exemplary claims 122 to 127 wherein the head portion comprises a base structure and a plurality of tuft blocks coupled to the base structure, the first and second bends located on opposite sides of a first one of the plurality of tuft blocks.

Exemplary claim 129. The head of any one of exemplary claims 122 to 128 wherein the head portion comprises a base structure, the connector of the head portion coupled to the base structure.

Exemplary claim 130. The head of exemplary claim 129 wherein the connector of the head portion is an integrally formed, monolithic, portion of the base structure.

Exemplary claim 131. The head of any one of exemplary claims 122 to 130 further comprising a third bend located along the wall, wherein the third bends has a spring rate, the spring rate of the third bend being less than the spring rates of the first and second bends.

Exemplary claim 132. The head of any one of exemplary claims 122 to 131 wherein a first one of the plurality of fingers comprises a third tuft block and a fourth tuft block, a third bend located between the wall and the third tuft block and a fourth bend located between the third tuft block and the fourth tuft block.

Exemplary claim 133. A method of assembling a head of an oral care implement comprising: a) providing a head portion of a head, the head portion comprising a wall, a plurality of fingers extending from the wall, a connector coupled to the wall, and first and second bends located along the wall; and b) coupling a connector of a neck portion to the connector of the head portion such that the connector of the neck portion is in contact with the first and second bends of the head portion.

Exemplary claim 134. The method of exemplary claim 133 wherein, in step a), the head portion comprises a base structure, a plurality of tuft blocks having a front surface and bristle tufts extending from the front surface, and a guard structure covering the base structure.

Exemplary claim 135. The method of exemplary claim 134 further comprising step a-1), wherein, in step a-1), the wall is bent at the first and second bends.

Exemplary claim 136. The method of exemplary claims 134 to 135 wherein a first one of the plurality of tuft blocks is located between the first and second bends.

Exemplary claim 137. The method of any one of exemplary claims 133 to 136 wherein the first and second bends have a spring rate, the spring rates of the first and second bends increased by coupling the connector of the neck portion to the connector of the head portion.

Exemplary claim 138. An oral care implement comprising: a handle; and a head coupled to the handle, the head comprising: a neck portion; and a head portion coupled to the neck portion, the head portion comprising: a base structure extending from a proximal end to a distal end, the proximal end coupled to the neck portion; a tuft block in contact with the base structure at the distal end of the base structure, the tuft block comprising a front surface, a rear surface, a perimeter extending from the front surface to the rear surface, and a plurality of bristle tufts extending from the front surface of the tuft block; and a guard structure, the guard structure covering the base structure.

Exemplary claim 139. The oral care implement of exemplary claim 138 wherein the tuft block comprises a plurality of tuft holes formed in the front surface, the plurality of tuft holes receiving the plurality of bristle tufts.

Exemplary claim 140. The oral care implement of exemplary claim 139 wherein the plurality of tuft holes extend through the base structure.

Exemplary claim 141. The oral care implement of any one of exemplary claims 138 to 140 wherein the base structure comprises an aperture, a coupling portion of the tuft block extending through the aperture.

Exemplary claim 142. The oral care implement of any one of exemplary claims 138 to 141 wherein the tuft block comprises a front portion, a rear portion, and a coupling portion, the front portion in contact with a front surface of the base structure and the rear portion in contact with a rear surface of the base structure, the coupling portion joining the front portion to the rear portion.

Exemplary claim 143. The oral care implement of any one of exemplary claims 138 to 142 wherein the guard structure surrounds the perimeter of the tuft block.

Exemplary claim 144. The oral care implement of any one of exemplary claims 138 to 143 wherein the base structure intersects the tuft block between the front surface and the rear surface of the tuft block.

Exemplary claim 145. The oral care implement of any one of exemplary claims 138 to 144 wherein the tuft block comprises a plurality of protuberances extending from the rear surface of the tuft block.

Exemplary claim 146. The oral care implement of exemplary claim 145 wherein the guard structure covers the rear surface of the tuft block, the plurality of protuberances remaining exposed.

Exemplary claim 147. The oral care implement of any one of exemplary claims 138 to 146 wherein the front surface of the tuft block and the guard structure are flush at an interface.

Exemplary claim 148. The oral care implement of any one of exemplary claims 138 to 147 wherein the base structure is formed of sheet metal.

Exemplary claim 149. The oral care implement of any one of exemplary claims 138 to 148 wherein the base structure has a front surface and an opposite rear surface, the guard structure covering the rear surface of the base structure.

Exemplary claim 150. The oral care implement of any one of exemplary claims 138 to 149 wherein the base structure has a front surface and an opposite rear surface, the base structure, the tuft block, and the neck portion covering the rear surface of the base structure.

Exemplary claim 151. The oral care implement of any one of exemplary claims 138 to 150 wherein the tuft block is formed of a hard plastic.

Exemplary claim 152. The oral care implement of any one of exemplary claims 138 to 151 wherein the guard structure is formed of an elastomeric material.

Exemplary claim 153. The oral care implement of any one of exemplary claims 138 to 152 wherein the head portion further comprises a connector configured to engage the neck portion, the connector integrally formed and monolithic with the base portion.

Exemplary claim 154. A head of an oral care implement comprising: a neck portion; and a head portion coupled to the neck portion, the head portion comprising: a base structure having a front surface, an opposite rear surface, and an aperture extending from the front surface to the rear surface; a tuft block comprising a front surface, a rear surface, and a plurality of bristle tufts extending from the front surface of the tuft block; and a guard structure, the guard structure covering the base structure; wherein a first one of the plurality of bristle tufts extends through the aperture of the base structure.

Exemplary claim 155. The head of exemplary claim 154 wherein the tuft block comprises a plurality of tuft holes formed in the front surface, the plurality of tuft holes receiving the plurality of bristle tufts.

Exemplary claim 156. The head of exemplary claim 155 wherein the plurality of tuft holes extend through the base structure.

Exemplary claim 157. The head of any one of exemplary claims 154 to 156 wherein a coupling portion of the tuft block extends through the aperture.

Exemplary claim 158. The head of any one of exemplary claims 154 to 157 wherein the tuft block comprises a front portion, a rear portion, and a coupling portion, the front portion in contact with the front surface of the base structure and the rear portion in contact with the rear surface of the base structure, the coupling portion joining the front portion to the rear portion.

Exemplary claim 159. The head of any one of exemplary claims 154 to 158 wherein a first portion of the front surface of the base structure is in direct surface contact with the tuft block.

Exemplary claim 160. The head of any one of exemplary claims 154 to 159 wherein the tuft block comprises a perimeter extending from the front surface to the rear surface.

Exemplary claim 161. The head of exemplary claim 160 wherein the base structure intersects the perimeter of the tuft block.

Exemplary claim 162. The head of any one of exemplary claims 154 to 161 wherein the base structure intersects the tuft block between the front surface and the rear surface of the first one of the plurality of tuft blocks.

Exemplary claim 163. The head of any one of exemplary claims 154 to 162 wherein the base structure is formed of sheet metal.

Exemplary claim 164. The head of any one of exemplary claims 154 to 163 wherein the tuft block is formed of a hard plastic.

Exemplary claim 165. The head of any one of exemplary claims 154 to 164 wherein the guard structure is formed of an elastomeric material.

Exemplary claim 166. The head of any one of exemplary claims 154 to 165 wherein the base structure is directly coupled to the neck portion.

Exemplary claim 167. The head of any one of exemplary claims 154 to 166 wherein the head portion further comprises a connector configured to engage the neck portion, the connector integrally formed and monolithic with the base portion.

Exemplary claim 168. The head of any one of exemplary claims 154 to 167 wherein the base portion has a first portion and a second portion, the first portion in contact with the tuft block and the second portion extending from the neck portion to the first portion.

Exemplary claim 169. The head of exemplary claim 168 wherein the first portion has a first width and the second portion has a second width, the first width greater than the second width.

Exemplary claim 170. A method of manufacturing a head of an oral care implement comprising: a) providing a base structure, the base structure comprising a front surface and an opposite rear surface; b) forming a tuft block comprising a plurality of tuft holes extending from a front surface of the tuft block, the first tuft block in contact with a first portion of the front surface of the base structure or a first portion of the rear surface of the base structure; and c) covering the front and rear surfaces of the base structure while leaving the front surface of the tuft block exposed to form a head subassembly.

Exemplary claim 171. The method of exemplary claim 170 further comprising step d), wherein, in step d), a plurality of bristle tuft bundles are inserted into the plurality of tuft holes of the tuft block to form a plurality of bristle tufts.

Exemplary claim 172. The method of exemplary claim 171 wherein the plurality of bristle tuft bundles comprise a base portion and a free portion, wherein in step d), the base portion of each of the plurality of bristle tuft bundles is inserted within a respective one of the plurality of tuft holes such that each of the base portions of the plurality of bristle tuft bundles extends through the base structure.

Exemplary claim 173. The method of any one of exemplary claims 170 to 172 wherein, in step b), the tuft block comprises a front portion, a rear portion, and a coupling portion, the front portion in contact with the front surface of the base structure and the rear portion in contact with the rear surface of the base structure, the coupling portion joining the front portion to the rear portion.

Exemplary claim 174. The method of any one of exemplary claims 170 to 173 wherein, in step b), the tuft block is in direct surface contact with both the front and rear surfaces of the base structure.

Exemplary claim 175. The method of any one of exemplary claims 170 to 174 wherein, in step a), the base structure comprises an aperture, a coupling portion of the tuft block extending through the aperture.

Exemplary claim 176. The method of any one of exemplary claims 170 to 174 further comprising step b-1), step b-1) comprising forming a neck portion on a proximal end of the base portion.

Exemplary claim 177. The method of any one of exemplary claims 170 to 176 wherein, in step b), the tuft block is formed on a distal end of the base portion.

What is claimed is:

1. An oral care implement comprising:
a handle; and
a head coupled to the handle, the head comprising:
a neck portion; and
a head portion coupled to the neck portion, the head portion comprising:
a base structure;
a plurality of tuft blocks in contact with the base structure, each of the plurality of tuft blocks comprising a front surface, a rear surface, a perimeter extending from the front surface to the rear surface, and a plurality of bristle tufts extending from the front surface of each of the plurality of tuft blocks; and
a guard structure, the guard structure encapsulating the base structure and surrounding the perimeter of a first one of the plurality of tuft blocks.

2. The oral care implement according to claim 1 wherein each of the plurality of tuft blocks comprises a plurality of tuft holes formed in the front surface, the plurality of tuft holes receiving the plurality of bristle tufts.

3. The oral care implement according to claim 1 wherein the base structure comprises an aperture, a coupling portion of the first one of the plurality of tuft blocks extending through the aperture.

4. The oral care implement according to claim 1 wherein the plurality of tuft blocks comprise a front portion, a rear portion, and a coupling portion, the front portion in contact with a front surface of the base structure and the rear portion in contact with a rear surface of the base structure, the coupling portion joining the front portion to the rear portion.

5. The oral care implement according to claim 1 wherein the base structure has a front surface and an opposite rear surface, a first portion of the front surface of the base structure in direct surface contact with the first one of the plurality of tuft blocks.

6. The oral care implement according to claim 1 wherein the first one of the plurality of tuft blocks comprises a plurality of protuberances extending from the rear surface of the first one of the plurality of tuft blocks, wherein the guard structure covers the rear surface of the first one of the plurality of tuft blocks, the plurality of protuberances remaining exposed.

7. The oral care implement according to claim 1 wherein the front surface of the first one of the plurality of tuft blocks and the guard structure are flush at an interface.

8. The oral care implement according to claim 1 wherein the head portion comprises a concave wall and a plurality of fingers extending from the wall.

9. The oral care implement according to claim 8 wherein the plurality of fingers each comprise a horizontal portion extending from the wall along a horizontal plane, and wherein each of the plurality of fingers comprise a bend and a tip portion, the tip portion of the fingers diverging from the horizontal plane at the bend.

10. The oral care implement according to claim 1 wherein the base structure has a front surface and an opposite rear surface, the guard structure encapsulating the rear surface of the base structure.

11. The oral care implement according to claim 1 wherein the base structure has a front surface and an opposite rear surface, the base structure and the plurality of tuft blocks collectively covering an entirety of the rear surface of the base structure.

12. A head of an oral care implement comprising:
a neck portion; and
a head portion coupled to the neck portion, the head portion comprising:
a base structure having a front surface and an opposite rear surface;
a plurality of tuft blocks, each of the plurality of tuft blocks comprising a front surface, a rear surface, and a plurality of bristle tufts extending from the front surface of each of the plurality of tuft blocks; and
a guard structure, the guard structure encapsulating the base structure;
wherein a first portion of the front surface of the base structure is in direct surface contact with a first one of the plurality of tuft blocks.

13. The head according to claim 12 wherein each of the plurality of tuft blocks comprises a plurality of tuft holes formed in the front surface, the plurality of tuft holes receiving the plurality of bristle tufts.

14. The head according to claim 13 wherein the plurality of tuft holes extend through the base structure.

15. The head according to claim 12 wherein the base structure comprises an aperture, a coupling portion of the first one of the plurality of tuft blocks extending through the aperture.

16. The head according to claim 12 wherein the plurality of tuft blocks comprise a front portion, a rear portion, and a coupling portion, the front portion in contact with the front surface of the base structure and the rear portion in contact with the rear surface of the base structure, the coupling portion joining the front portion to the rear portion.

17. The head according to claim 12 wherein a first portion of the front surface of the base structure is in direct surface contact with the first one of the plurality of tuft blocks.

18. The head according to claim 12 wherein each of the plurality of tuft blocks comprises a perimeter extending from the front surface to the rear surface.

19. The head according to claim 18 wherein the base structure intersects the perimeter of the first one of the plurality of tuft blocks.

20. A method of manufacturing a head of an oral care implement comprising:
a) providing a base structure, the base structure comprising a front surface and an opposite rear surface;
b) forming a first tuft block comprising a plurality of tuft holes extending from a front surface, the first tuft block in contact with a first portion of the front surface of the base structure or a first portion of the rear surface of the base structure; and
c) encapsulating the front and rear surfaces of the base structure while leaving the front surface of the first tuft block exposed to form a head subassembly.
